(19) United States
(12) Patent Application Publication
(10) Pub. No.: US 2026/0084335 A1
(43) Pub. Date: Mar. 26, 2026

(54) CHIPPING, PROFILING, AND SAWING SYSTEMS FOR LUMBER PRODUCTION

(71) Applicant: USNR, LLC, Woodland, WA (US)

(72) Inventors: Anthony J. La Salata, Vancouver, WA (US); Petri Jalmari Saastamo, Woodland, WA (US); Matthew L. Ballantyne, Longview, WA (US)

(21) Appl. No.: 19/337,350

(22) Filed: Sep. 23, 2025

Related U.S. Application Data
(60) Provisional application No. 63/698,039, filed on Sep. 23, 2024.
(60) Provisional application No. 63/698,559, filed on Sep. 24, 2024.

(51) Int. Cl. B27B 5/06; B27B 25/04; B27B 31/00

(52) U.S. Cl. CPC B27B 5/06; B27B 25/04; B27B 31/006

(57) ABSTRACT

The present disclosure provides embodiments of systems and apparatuses for cutting workpieces (e.g., logs or cants) into lumber. In some embodiments, a saw module includes a saw box that is suspended from a beam, movable laterally and vertically relative to the beam, and pivotable about a vertical pivot axis. Embodiments of a chipper profiler module, an infeed module, a mid-feed module, and an outfeed module are also disclosed. A system for cutting workpiece into lumber may include any of the modules in various combinations.

### CROSS-REFERENCE TO RELATED APPLICATIONS

The present claims the benefit of U.S. Provisional Patent Application Ser. No. 63/698,039 filed Sep. 23, 2024 and titled “CHIPPING, PROFILING, AND SAWING SYSTEMS FOR LUMBER PRODUCTION” and U.S. Provisional Patent Application Ser. No. 63/698,559 filed Sep. 24, 2024 and titled “CHIPPING, PROFILING, AND SAWING SYSTEMS FOR LUMBER PRODUCTION,” the entire disclosures of which are hereby incorporated by reference herein.

### TECHNICAL FIELD

The present disclosure relates to lumber production, and more specifically to apparatuses, methods, and systems for cutting logs and cants into lumber.

### BACKGROUND

In large commercial sawmills that produce softwood lumber, logs are cut into boards in two stages. In the first stage—primary breakdown—one pair or two pairs of opposing flat faces are machined longitudinally along the log to form a two-sided or four-sided cant, respectively.

In the second stage, or secondary breakdown, the remaining cant is conveyed through a gang saw that cuts the cant longitudinally into boards. In some cases, longitudinal through-cuts are made parallel to one or more of the flat faces to cut flitches or side boards from the cant before the remaining cant is sent to the gang saw.

Typical gang saws used for this purpose have a pair of arbors, each with multiple circular saw blades, arranged on opposite sides of the feed axis. The spacing of the saw blades along the arbors determines the number and thicknesses of the boards sawn from the cant. Most logs and cants have some degree of curvature along their lengths. Cutting a cant along its curvature helps to maximize wood volume recovery from the cant.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIGS. 1A and 1B are perspective views of a workpiece processing system;

FIG. 1C is a top plan view of the workpiece processing system of FIGS. 1A and 1B;

FIGS. 2A and 2B are side elevational views of the workpiece processing system of FIGS. 1A-C;

FIG. 3 is a side elevational view as in 2A, with some components removed;

FIG. 4 is a front elevational view of the workpiece processing system, with the infeed module in operating mode;

FIG. 5 is a side elevational view of the infeed, chipper profiler, mid-feed, shape saw, and outfeed modules;

FIGS. 6A, 6B, and 6C are front elevational, perspective, and side elevational views, respectively, of an infeed module;

FIG. 6D shows additional details of the infeed module of FIGS. 6A-6C;

FIGS. 7A and 7B are a partial front elevational view and a plan view, respectively, of the workpiece processing system with the infeed module positioned in maintenance mode;

FIG. 8A is a perspective view of a chipper profiler module;

FIGS. 8B and 8C are perspective views of a chipper profiler module with some components removed for clarity;

FIG. 9A is a front elevational view of the chipper profiler module;

FIG. 9B is a sectional view of the chipper profiler module taken along lines A-A of FIG. 9A;

FIG. 9C is an enlarged view of a portion of FIG. 9B, with some components removed for clarity;

FIGS. 10A and 10B are sectional views taken along a longitudinal center plane of the chipper profiler module;

FIGS. 11A and 11B are partial perspective views of the chipper assembly (FIG. 11A) and the profiler assembly (FIG. 11B) relative to portions of the frame;

FIGS. 11C and 11D are perspective views of the chipper assembly (FIG. 11C) and the profiler assembly (FIG. 11D) with some components removed for clarity;

FIGS. 12A and 12B are rear elevational and perspective views, respectively, of a mid-feed module with relevant components in the operational position;

FIGS. 12C and 12D are end elevational and partial perspective views of a portion of the mid-feed module of FIGS. 13A-13B, with some components removed for clarity;

FIGS. 13A and 13B are perspective views of another embodiment of a mid-feed module with relevant components in the operational position (FIG. 13A) and in the maintenance position (FIG. 13B);

FIGS. 13C and 13D are rear elevational views of the mid-feed module of FIGS. 13A-13B with the relevant components in the operational position (FIG. 13C) and in the maintenance position (FIG. 13D);

FIG. 13E is a rear elevational view of the carriage of the mid-feed module of FIGS. 13A-13D;

FIGS. 13F and 13G are perspective views of the feed roll assembly of the mid-feed module of FIGS. 13A-13E;

FIGS. 14A and 14B are perspective views of a saw module;

FIGS. 14C and 14D are rear and front elevational views, respectively, of the saw module of FIGS. 14A-14B;

FIG. 15A is a sectional view taken along lines A-A of FIG. 14C;

FIG. 15B is a sectional view taken along lines B-B of FIG. 14D:

FIG. 16A is a partial perspective view of components of the saw assembly of FIGS. 14A-15B, with other components removed for clarity;

FIGS. 16B and 16C are perspective views of a first support assembly (FIG. 16B) and a second support assembly (FIG. 16C), and other components, of the saw assembly;

FIGS. 17A, 17B, and 17C are partly exploded views of components of the saw assembly shown in FIGS. 16B-16C;

FIGS. 18A, 18B, and 18C are partly exploded views of components of the saw assembly shown in FIGS. 16B-16C;

FIGS. 19A and 19B are sectional views of the saw assembly of FIGS. 16B-18C, shown in perspective;

FIGS. 20A, 20B, and 20C are perspective views illustrating operations of saw assembly components to raise and lower (FIGS. 20A, 20B) and pivot (FIG. 20C) the saw box;

FIGS. 21A and 21B are partial perspective and end elevational views, respectively, of another embodiment of a saw assembly;

FIG. 22 is an end elevational view of components of the saw assembly of FIG. 21, with components removed for clarity;

FIGS. 23A and 23B are perspective views of the saw assembly shown in FIG. 22, with components removed for clarity;

FIG. 24 is an elevational view of the saw assembly shown in FIG. 22, with components removed for clarity;

FIGS. 25A and 25B are sectional views taken along lines A-A of FIG. 24, and viewed in perspective, illustrating operations of the saw assembly to raise and lower the saw box;

FIGS. 26A and 26B are perspective views of an outfeed module;

FIGS. 27-29 show another embodiment of a workpiece processing system with multiple cutting modules and feed modules; and

FIGS. 30-54 show additional views, components, and features, all in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized, and structural or logical changes may be made, without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

In various embodiments, a computing device may be endowed with one or more components of the disclosed apparatuses and/or systems and may be employed to perform one or more methods as disclosed herein.

For the purposes of this description, the term “flitch” refers to a piece of wood that has machined faces and wane edges that are not machined. For example, cutting a two-sided cant longitudinally, substantially parallel to one of the machined faces of the cant, yields a flitch and a rem.

For the purposes of this description, the term “side board” refers to a piece of wood that has machined faces and edges that are machined along at least part of their lengths.

The present disclosure provides embodiments of systems, methods, and apparatuses for cutting a workpiece, such as a log or a cant, longitudinally as the workpiece is moved lineally along a feed axis.

In various embodiments, the system has at least one cutting module. The cutting module includes a frame and a cutting assembly mounted to the frame. The frame includes a horizontal beam that extends above, and transverse to, the feed axis. The cutting assembly is slideably mounted to, and suspended from, the horizontal beam such that the cutting assembly is movable in opposite directions along a horizontal path that is transverse to the feed axis. Optionally, the system may further include one or more additional cutting modules and/or one or more feed modules.

In various embodiments, an infeed module includes a feed assembly with a frame, an upper feed member assembly, and a lower feed member assembly. Each of the feed member assemblies includes one or more feed members (e.g., rolls, belts, or chains) and a corresponding drive system. Optionally at least one of the feed member assemblies further includes a carriage assembly configured to raise and lower the respective feed member(s). The infeed module may optionally include a base, and the feed assembly may be slideably mounted to the base and movable along the base from a first position, in which the feed axis extends through the frame, and a second position in which the frame is to one side of the feed axis. The infeed module may optionally include a maintenance platform assembly mounted to the feed assembly. The maintenance platform assembly may include a movable platform that can be deployed to support a human operator thereon when the feed assembly is in the second position.

In various embodiments, a chipper profiler module includes a frame, a first chipper assembly, and a first profiler assembly. The frame includes a first beam and a second beam that are disposed above, and transverse to, the feed axis. The beams are oriented parallel to one another and spaced apart along the first direction. The first chipper assembly is slideably mounted to the first beam, and the first profiler assembly is slideably mounted to the second beam, such that the first chipper assembly and the first profiler assembly are movable independently of one another, along respective horizontal paths, in a first direction toward the feed axis and in a second direction away from the feed axis.

In some embodiments the first chipper assembly has a first upper carriage assembly and a first lower carriage assembly. The first upper carriage assembly has a first carriage configured to slideably engage a first rail disposed along the first beam. The first lower carriage assembly is coupled to the first upper carriage assembly and rotatable relative thereto about a first vertical axis. The first lower carriage assembly is configured to support a chipping head.

The first profiler assembly may have a second upper carriage assembly and a second lower carriage assembly. The second upper carriage assembly may have a second carriage configured to slideably engage a second rail disposed along the second beam. The second lower carriage assembly may be coupled to the second upper carriage assembly and rotatable about a second vertical axis. The second lower carriage assembly is configured to support an upper profiler head and a lower profiler head. For example, in some embodiments the second lower carriage assembly may include a support, and the upper profiler head and the lower profiler head may be movably mounted to the support such that the upper profiler head and the lower profiler head are vertically movable independently of one another relative to the support.

In some embodiments, each of the first and second beams has a top and a bottom joined by an upstream side and a downstream side, and the first beam is upstream of the second beam. The first chipper assembly is slideably mounted to the downstream side of the first beam, and the first profiler assembly is slideably mounted to the upstream side of the second beam, such that a portion of the first profiler assembly and a portion of the second profiler assembly are between the first beam and the second beam. In that case, a first set of rails may be mounted to the downstream side of the first beam and a second set of rails may be mounted to the upstream side of the second beam, and each of the sets of rails may have a respective upper rail and a respective lower rail that extend horizontally and parallel to one another. The first chipper assembly may have a first set of carriages slideably mounted to the first set of rails, and the first profiler assembly may have a second set of carriages slideably mounted to the second set of rails.

Optionally, the first chipper assembly includes a first chip head, and the first profiler assembly includes an upper profiler head and a lower profiler head. The first chip head may be pivotable about a first vertical axis, the upper and lower profiler heads may be pivotable about a second vertical axis independently of the first chip head. The upper profiler head and the lower profiler head may be vertically movable independently of one another. Optionally a feed assembly may be mounted to a downstream end of the frame. The feed assembly may be movable laterally, relative to the frame, between an operational position in which the feed axis extends through the feed module and a maintenance position in which the feed module is located to one side of the feed axis.

In various embodiments, a mid-feed module may be provided between two modules, such as between a chipper profiler module and a saw module. The mid-feed module may be slideably mounted to a frame of one of the cutting modules, or to a separate frame. The mid-feed module, or a portion thereof, may be slideable laterally, relative to the frame, between an operating position (in which the feed axis extends through the mid-feed module) and a maintenance position to one side of the feed axis.

In various embodiments, a saw module has a frame, a first support assembly, a second support assembly, and a saw box. The frame has a pair of horizontal beams that are disposed above, and transverse to, the feed axis and spaced apart along the first direction. The first support assembly includes a first platform that is supported on, and slideably mounted to, the horizontal beams. The second support assembly is supported by, and pivotably coupled to, the first support assembly. The second support assembly includes a second platform and a cylinder. The second platform is disposed above the first platform, the cylinder extends through the first platform and between the beams, and a first end of the cylinder is fixedly coupled to the second platform. The saw box is fixedly coupled to an opposite second end of the cylinder, such that the saw box is supported by the second support assembly and disposed below the beams. In this configuration the first support assembly is movable, relative to the beams, in opposite directions along a horizontal path that is above and transverse to the first direction to thereby move the saw box laterally relative to the feed axis. The second support assembly is pivotable, relative to the first support assembly, about a vertical axis defined by the cylinder to thereby pivot the saw box about the vertical axis. The second platform and the cylinder are vertically movable, relative to the first platform, to thereby raise and lower the saw box.

In some embodiments the first support assembly further includes a ring bearing that has an outer ring and an inner ring. The outer ring may be fixedly mounted to the first platform and the inner ring may be rotatable relative to the outer ring.

The second support assembly may further include a third platform and a cylindrical tube. The third platform is disposed between the first platform and the second platform. The cylindrical tube is fixedly mounted to the third platform and the inner ring, and the cylinder is disposed through the cylindrical tube.

Some embodiments further include a first actuator mounted to the first platform and pivotably coupled to the third platform. The first actuator is actuable to pivot the second support assembly and the saw box around the vertical axis relative to the first platform. A second actuator may optionally be mounted to the second platform and connected to the third platform. The second actuator is actuable to raise and lower the second platform relative to the third platform to thereby raise and lower the saw box relative to the feed axis.

In some embodiments a linear actuator may be mounted to the frame and connected to the first platform. The linear actuator is actuable to move the first support assembly, relative to the beams, in opposite directions along the horizontal path to thereby move the saw box laterally relative to the feed axis.

In some embodiments, the saw module may further include an upper saw arbor and a lower saw arbor rotatably mounted to the saw box, and a first motor and a second motor operatively coupled with the first saw arbor and the second saw arbor, respectively, and supported on the second platform. The first motor and the second motor may be operable to drive the first and second arbors, respectively, in rotation.

In various embodiments, an outfeed module, infeed module, and/or mid-feed module may have opposing feed members such as upper feed rolls and lower feed rolls (or lower chains/belts). Optionally, some or all of the upper feed rolls are directly driven by respective motors through respective drivelines and right-angle reducers. In addition, some or all of the lower feed rolls are optionally directly driven by respective motors through respective couplings and reducers, which may be right-angle reducers or inline reducers. For example, in some embodiments the upper and lower feed rolls are driven by respective gear motors.

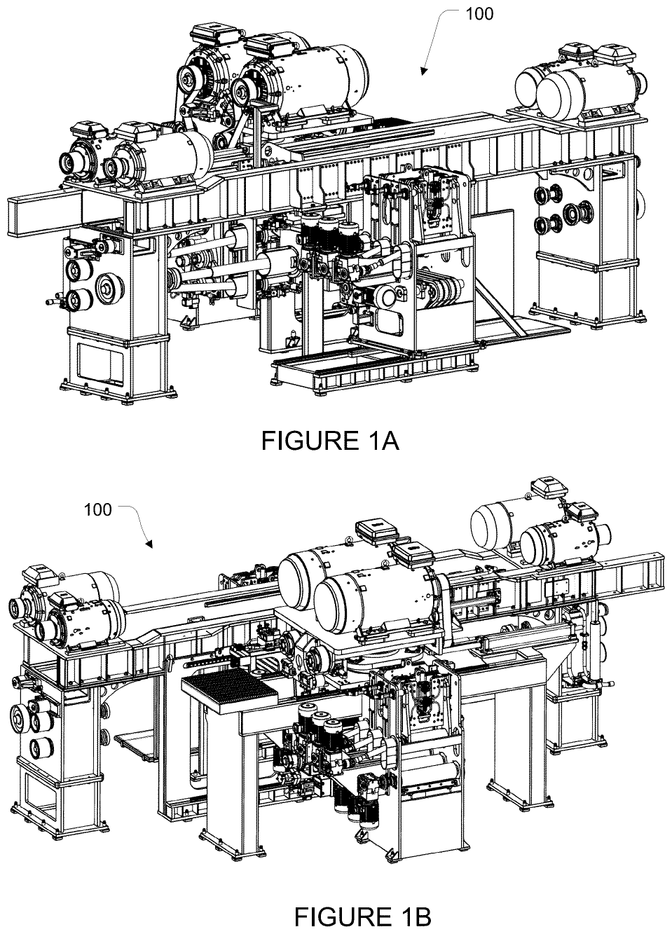

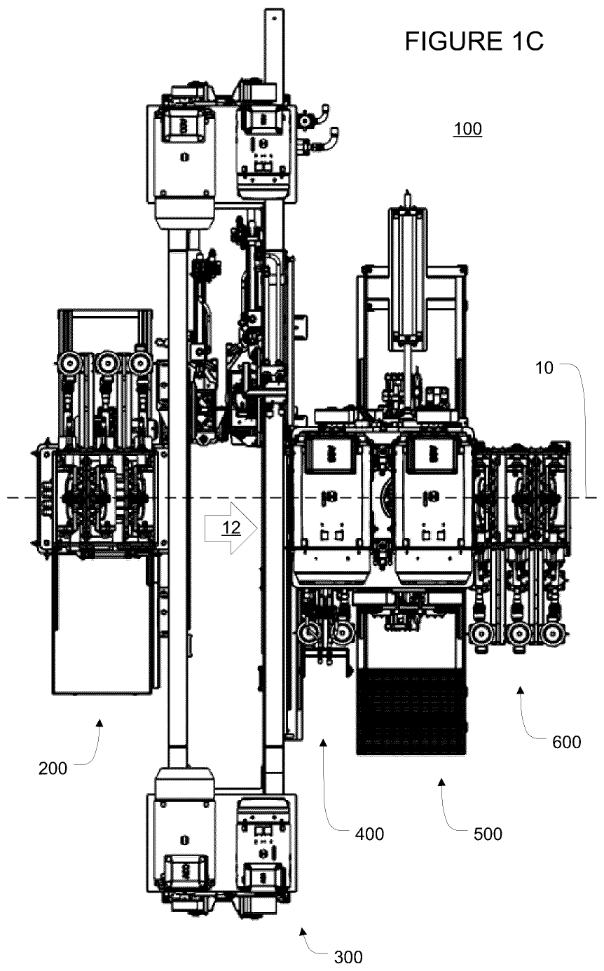

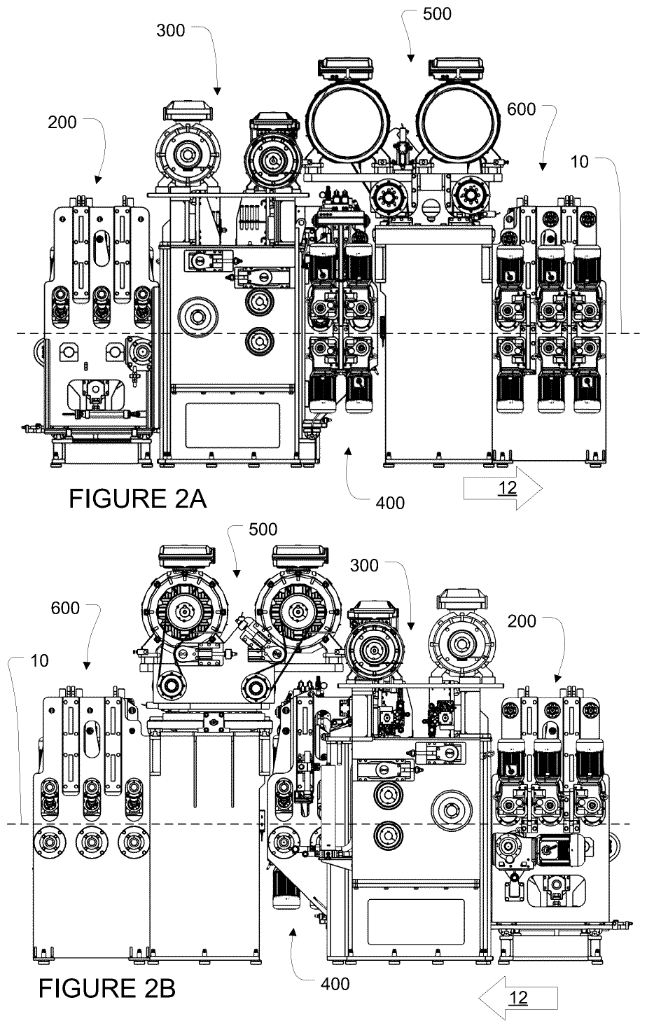

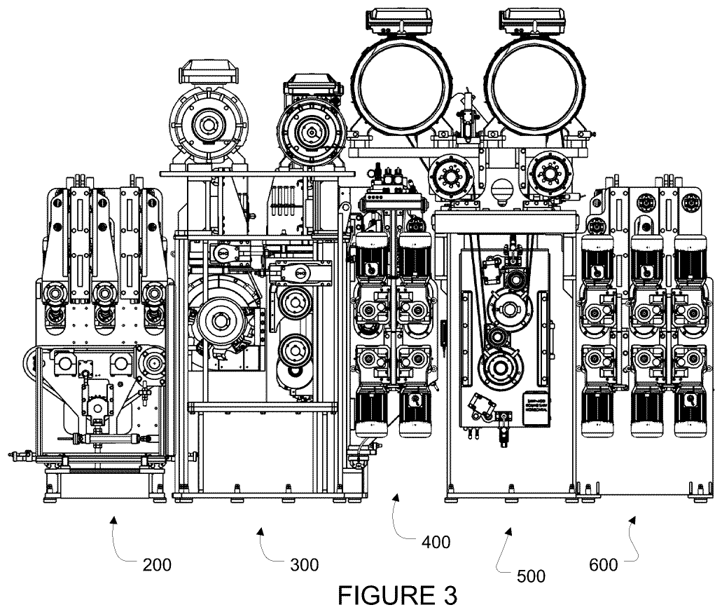

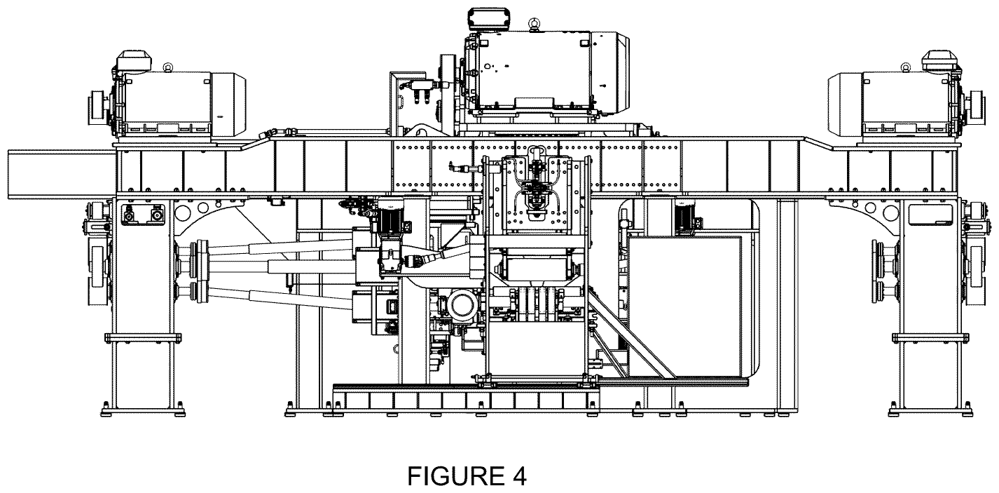

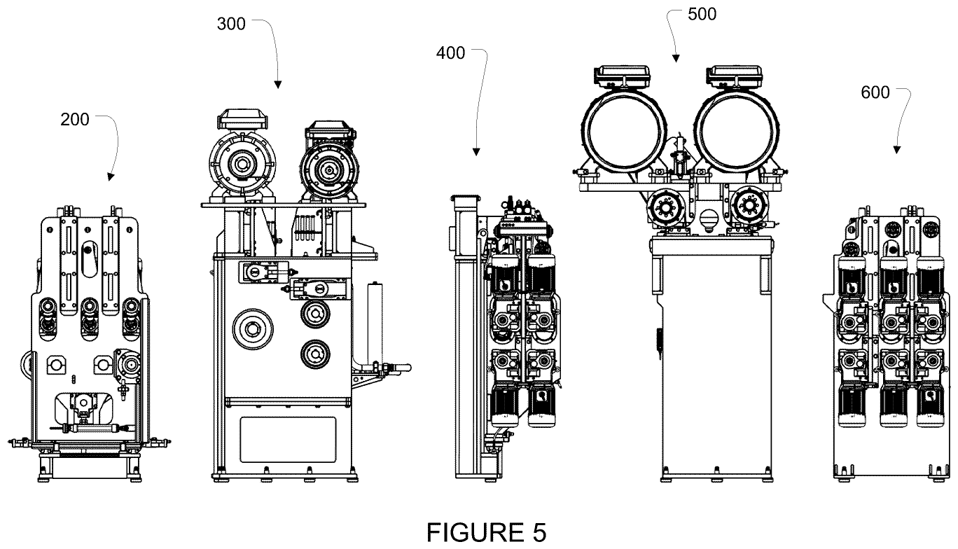

FIGS. 1A-5 illustrate an embodiment of a system 100 for cutting a workpiece, such as a log or a cant, longitudinally as it is moved lineally along a feed axis 10 in a feed direction 12.

In the illustrated embodiment, system 100 includes an infeed module 200, a chipper profiler module 300, a mid-feed module 400, a saw module 500, and an outfeed module 600 arranged along feed axis 10. While the illustrated system includes two cutting modules (one of which has multiple cutting assemblies) and three feed modules, the number and arrangement of cutting modules and feed modules varies among embodiments. In some embodiments, the system may have only one cutting module, or more than two cutting modules. Likewise, in some embodiments the system may lack a feed module or have more than three feed modules. Any of the feed modules 200/400/600, chipper profiler module 300, and saw module 500 may be provided individually, or as part of a system that includes any two or more of the modules.

Infeed module 200, mid-feed module 400, and outfeed module 600 are configured to move the workpiece along the feed axis 10, in the feed direction 12, through the cutting modules (chipper profiler module 300 and saw module 500).

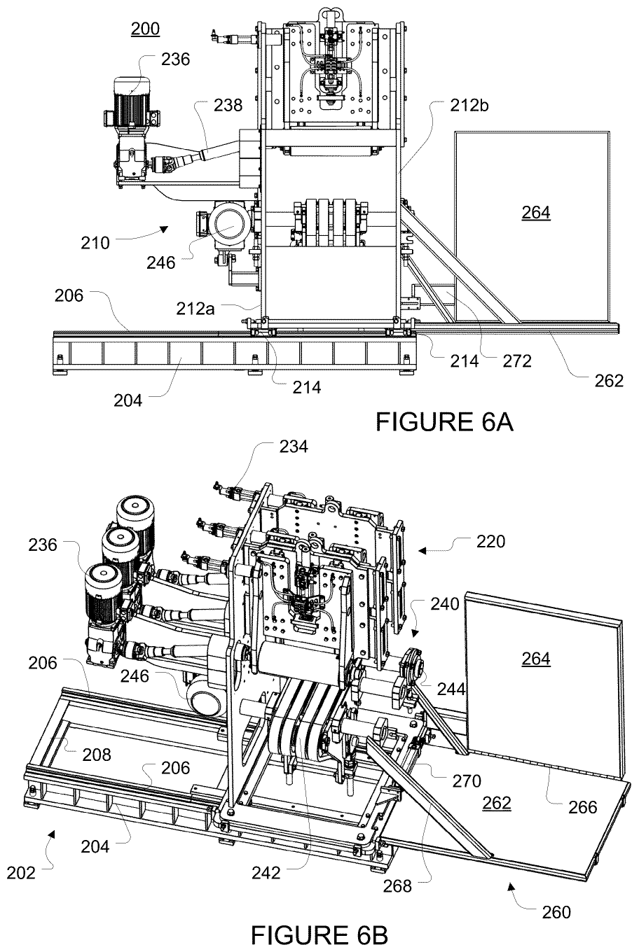

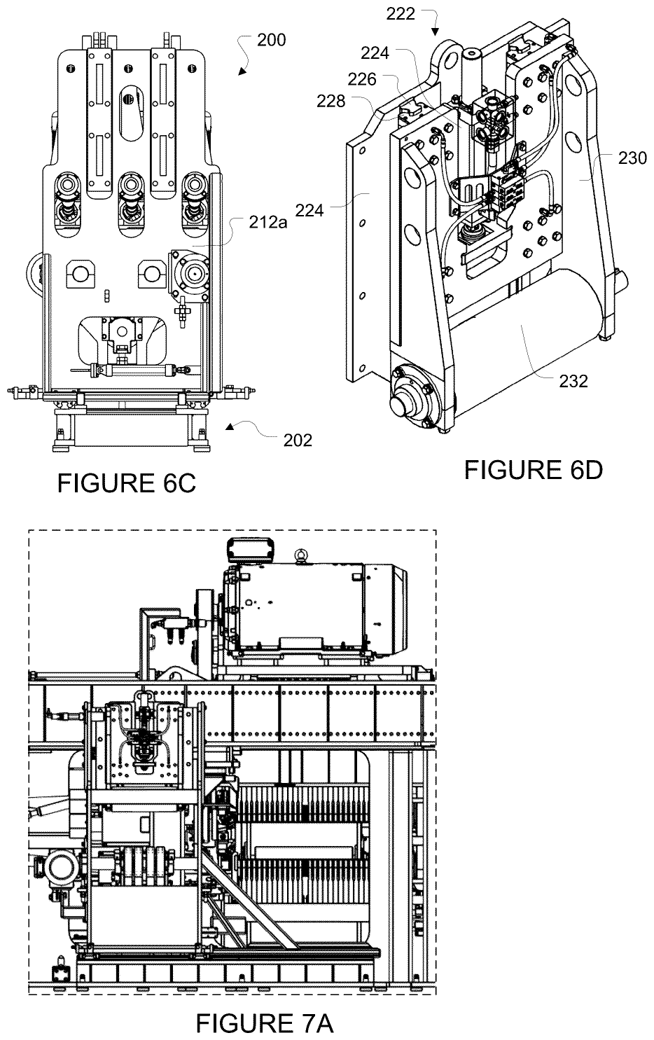

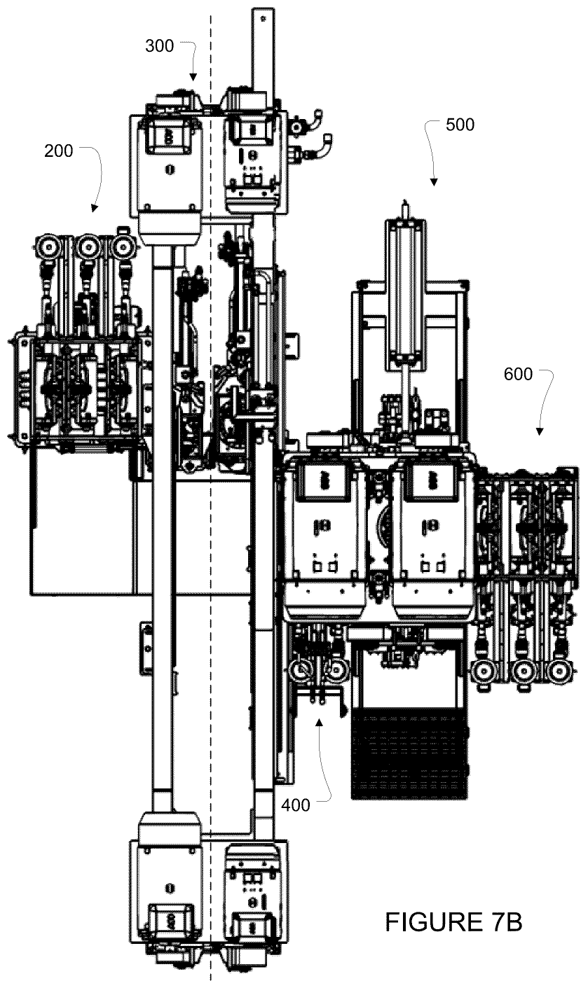

Referring now to FIGS. 6A-7B, infeed module 200 includes a base 202, a feed assembly 210 slideably mounted to the base 202, and a maintenance platform assembly 260 mounted to the feed assembly 210.

Base 202 includes a frame and a pair of rails 206 mounted on the frame. The frame includes longitudinal supports 204, such as beams, and may optionally include lateral supports 208 connecting the longitudinal supports 204. Rails 206 extend below, and transverse to, the feed axis 10.

Feed assembly 210 includes a frame, an upper feed member assembly 220, and a lower feed member assembly 240. The frame has opposite side walls 212a and 212b, and the feed member assemblies are mounted to the frame. Carriages 214 are mounted to the frame and movable along rails 206.

In the illustrated embodiment, upper feed member assembly 220 includes feed roll assemblies 222. Each feed roll assembly 222 has a support plate 224 with rails 226 (e.g., linear bearings), a press frame 230 with rail carriages 228 (e.g., linear bearing carriages), and a feed roll 232. Support plate 224 is mounted to, and extends between, the side walls 212a and 212b. Rails 226 are mounted to support plate 224 in a vertical orientation. Feed roll 232 is rotatably mounted to press frame 230, and rail carriages 228 mounted to the opposite side of press frame 230 engage the rails 226. This arrangement allows press frame 230 and corresponding feed roll 232 to be repositioned vertically to accommodate workpieces of different diameters. Each feed roll assembly 222 may optionally include a corresponding actuator 234 operatively connected to support plate 224 and press frame 230. For example, actuator 234 may be (or may include) a linear actuator, such as a hydraulic or pneumatic cylinder, connected to support plate 224 and press frame 230 and is selectively operable to move press frame 230 vertically relative to support plate 224. Optionally, upper feed member assembly 220 may also include one or more motors 236 operatively coupled with the feed roll(s) 232. Motor(s) 236 may be coupled with the respective feed roll(s) 232 by driveline(s) 238. Optionally driveline 238 may be an extendable and/or flexible driveline with a universal joint.

Lower feed member assembly 240 includes one or more endless members 242 (e.g., belts or chains) mounted to the frame of feed assembly 210. The endless member(s) 242 forms a workpiece support surface. Endless members 242 are operatively coupled with drive shaft 244, which is rotatably mounted to the side walls 112a and 112b and connected to a motor 246 that drives the endless member(s) in rotation in the feed direction.

Maintenance platform assembly 260 includes a fixed platform 262 and a movable platform 264 that is connected to fixed platform 262 by a hinge 266. Movable platform 264 is pivotable about the longitudinal axis of the hinge 266 from an upright position (shown in FIGS. 6A, 6B) to a support position (shown in FIGS. 7A, 7B), in which the upper surface of movable platform 264 is substantially horizontal and/or coplanar with the upper surface of fixed platform 262. Optionally, support members 268 (beams or the like) may be connected at opposite ends to fixed platform 262 and the frame of feed assembly 210.

Feed assembly 210 is movable along the rails 206 between an operational position (FIGS. 6A, 6B), in which the side walls 212a and 212b are on opposite sides of the feed axis, and a maintenance position (FIGS. 7A, 7B) in which feed assembly 210 is located to one side of the feed axis and the fixed platform 262 is aligned with the feed axis. While feed assembly 210 is in the maintenance position, the movable platform 264 can be moved from the upright position to the support position. With movable platform 264 in the support position, fixed platform 262 and movable platform 264 collectively form a support surface that extends at least part of the length of the system along the feed axis. For example, in the illustrated embodiment the support surface extends from an upstream end of infeed module 200 to saw module 500. This configuration allows a human operator to stand on the support surface to access, and to perform maintenance (e.g., saw/knife changes, repairs, etc.) on, chipper profiler module 300 and saw module 500.

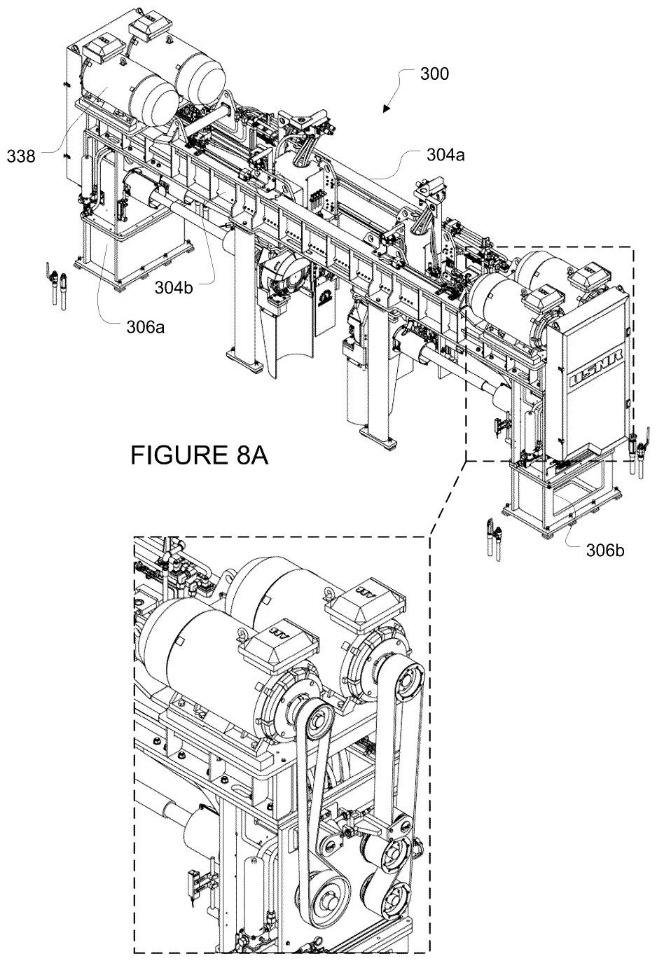

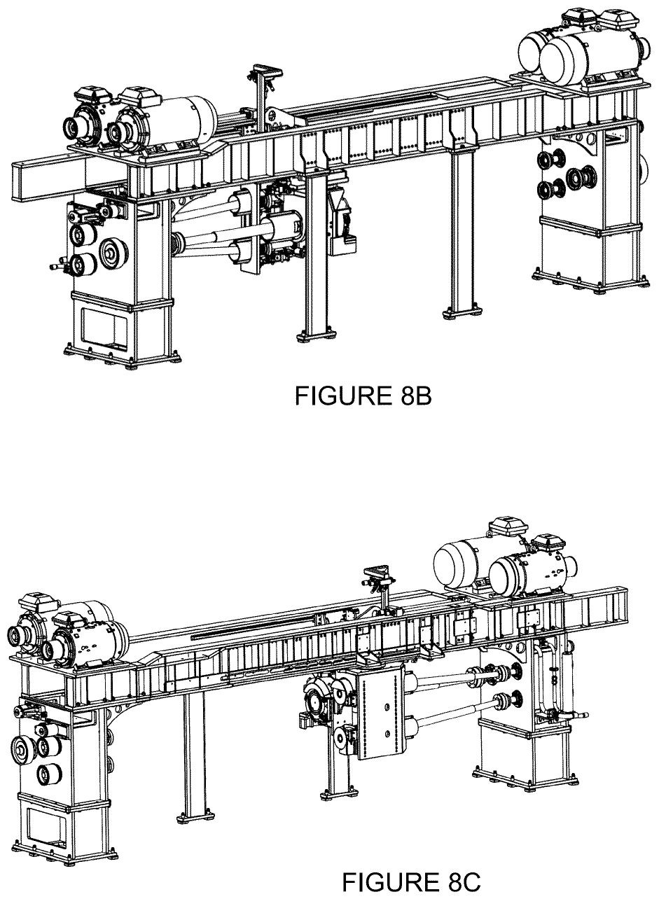

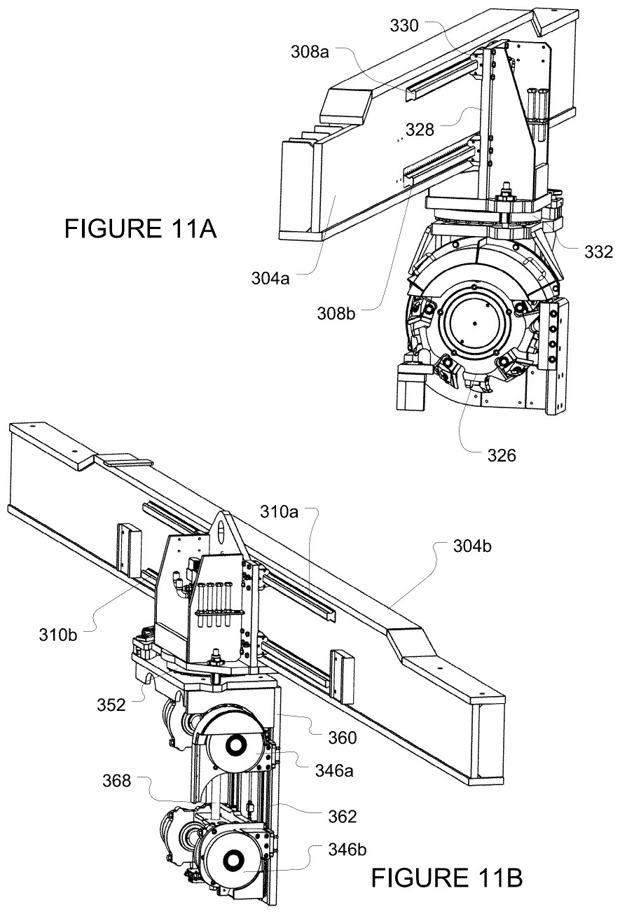

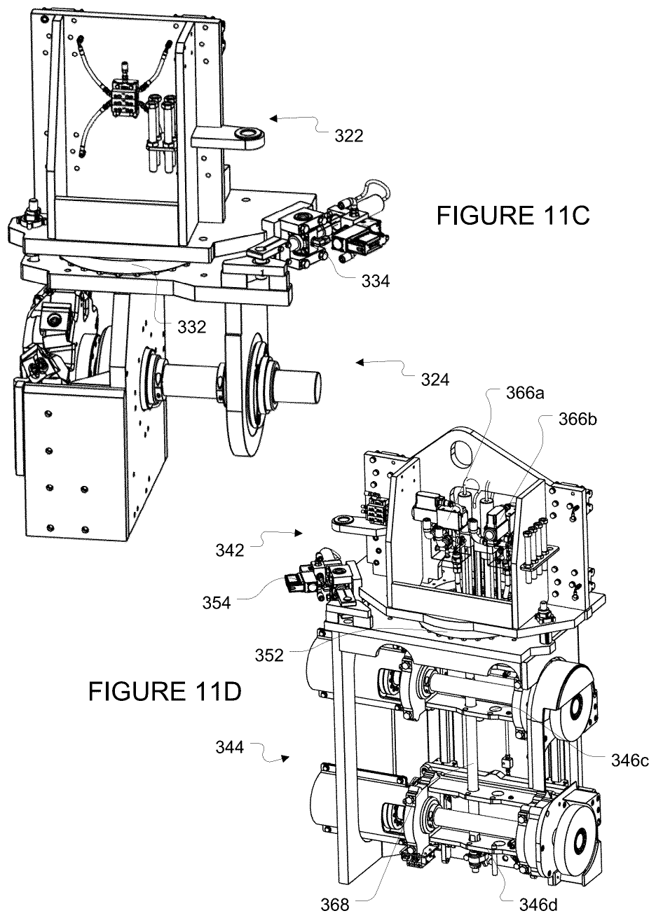

Referring now to FIGS. 8A-11D, chipper profiler module 300 may include a frame 302, a chipper assembly 320, and a profiler assembly 340.

Frame 302 includes a first beam 304a and a second beam 304b supported by upright supports 306a and 306b located on opposite sides of the feed axis. First beam 304a and second beam 304b extend above, and transverse to, the feed axis and are spaced apart in the feed direction. Rails 308a and 308b are mounted to first beam 304a, and rails 310a and 310b are mounted to second beam 304b.

Chipper assembly 320 is slideably mounted to first beam 304a, and profiler assembly 340 is slideably mounted to second beam 304b, such that both assemblies are movable in opposite directions along respective horizontal paths that are transverse to the feed axis 10. While FIGS. 8B-10B illustrate only one chipper assembly and one profiler assembly, the chipper profiler module 300 preferably includes a pair of chipper assemblies, and a pair of profiler assemblies, on opposite sides of the feed axis.

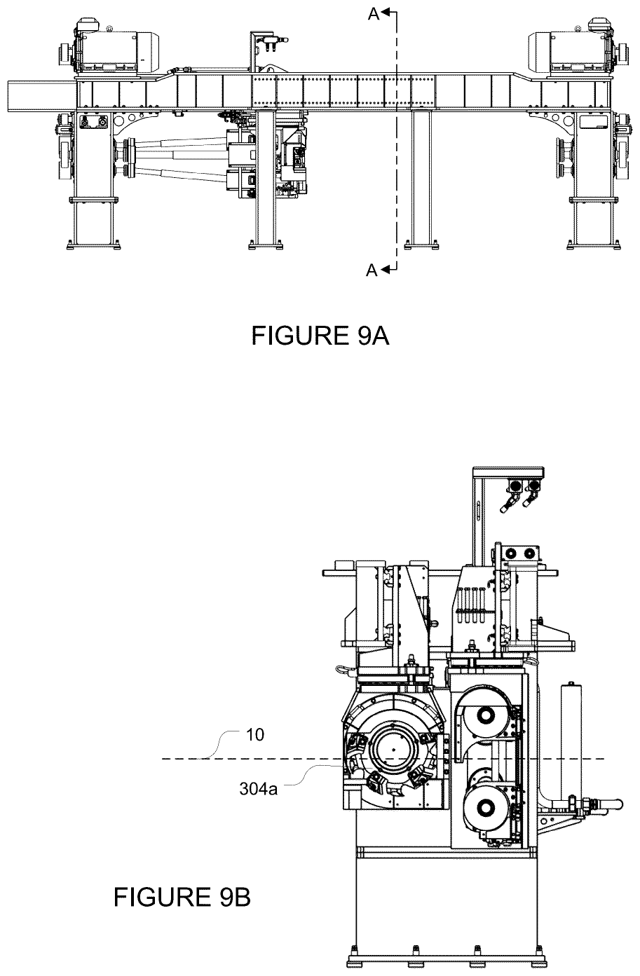

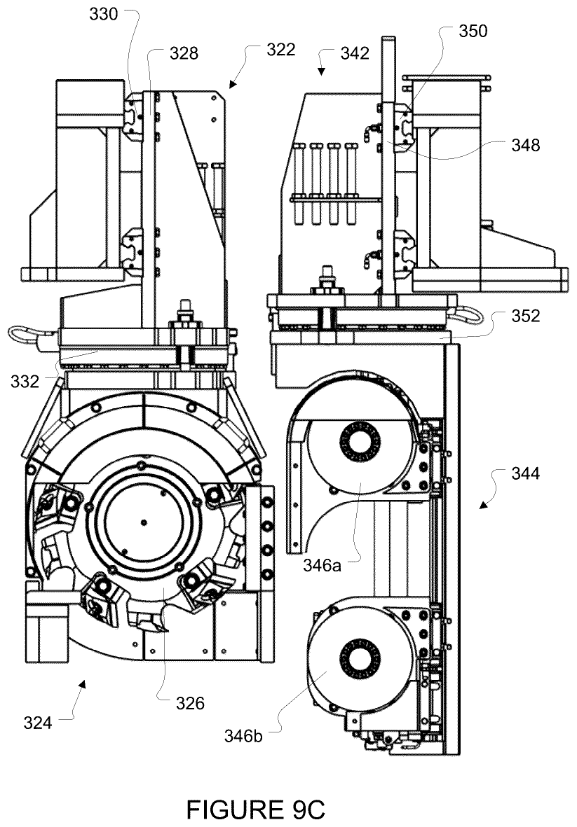

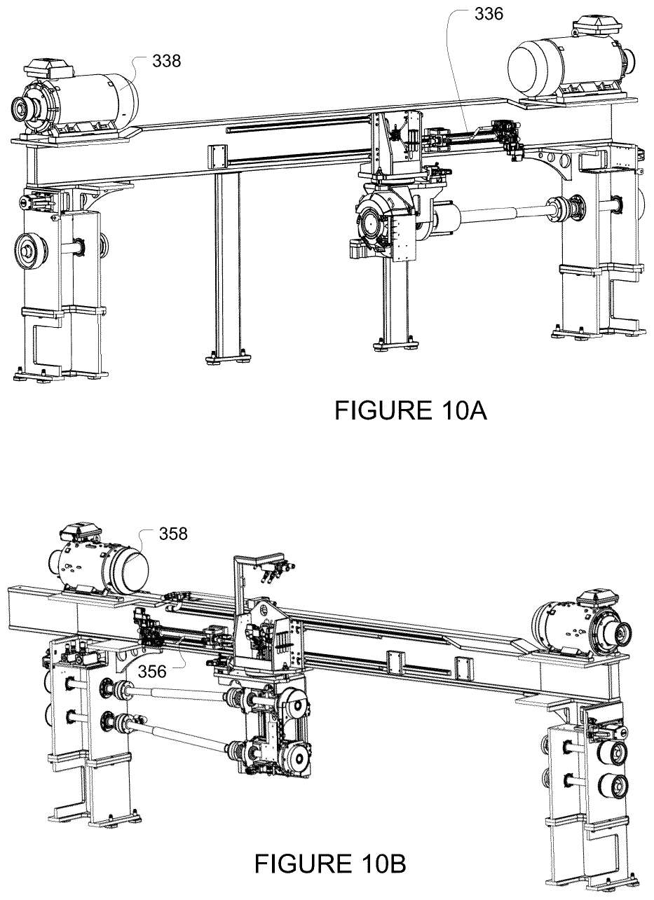

Chipper assembly 320 includes an upper carriage assembly 322 and a lower carriage assembly 324 (see e.g., FIG. 9C). The lower carriage assembly 324 is configured to support a chip head 326 rotatably mounted thereto. The upper carriage assembly includes a support member 328 (e.g., a plate) with carriages 330 that slideably engage rails 308a and 308b. The lower carriage assembly 324 is mounted to the upper carriage assembly by a ring bearing 332. Ring bearing 332 has an outer ring 332a that is fixedly mounted to the lower carriage assembly and an inner ring 332b that is fixedly mounted to the upper carriage assembly (or vice versa). The inner ring is rotatable relative to the outer ring, which permits rotation of the lower carriage assembly 324 relative to the upper carriage assembly 322. An actuator 334 (e.g., a pneumatic or hydraulic linear actuator) is connected to both the upper carriage assembly and the lower carriage assembly. Actuator 334 is selectively actuable to rotate the lower carriage assembly, relative to the upper carriage assembly, about a vertical axis that extends through the center of the ring bearing. A second actuator 336 mounted to first beam 304a and connected to the upper carriage assembly 322 is operable to move the chipper assembly 320 in opposite directions along rails 308a, 308b (see FIG. 10A). Motor 338 is operatively coupled with chip head 326 (e.g., via belts, drive lines, etc.) to drive chip head 324 in rotation.

Profiler assembly 340 includes an upper carriage assembly 342 and a lower carriage assembly 344. Lower carriage assembly 344 is configured to support an upper profiling head 346a and a lower profiling head 346b rotatably mounted thereto. The upper carriage assembly 342 includes a support member 348 (e.g., a plate) with carriages 350 that slideably engage rails 310a and 310b. The lower carriage assembly 344 is mounted to the upper carriage assembly 342 by a ring bearing 352. Ring bearing 352 has an outer ring 352a that is fixedly mounted to the lower carriage assembly 344 and an inner ring 352b that is fixedly mounted to the upper carriage assembly 342 (or vice versa). The inner ring 352a is rotatable relative to the outer ring 352b, which permits rotation of the lower carriage assembly 344 relative to the upper carriage assembly 342. An actuator 354 (e.g., a pneumatic or hydraulic linear actuator) is connected to both the upper carriage assembly and the lower carriage assembly. Actuator 354 is selectively actuable to rotate the lower carriage assembly, relative to the upper carriage assembly, about a vertical axis that extends through the center of the ring bearing. A second actuator 356 mounted to first beam 304a and connected to the upper carriage assembly 342 is operable to move the chipper assembly 320 in opposite directions along rails 310a, 310b (see FIG. 10B). Motor 358 is operatively coupled with profiler heads 346a, 346b (e.g., via belts, drive lines, etc.) to drive the profiler heads in rotation. In the illustrated embodiment, motors 338 and 358 are mounted on top of the beams 304a and 304b and are operatively connected to the chip heads and profiler heads, respectively, by drivelines (e.g., constant velocity drivelines). In this design, the drive belts and drivelines are exposed and easily accessible for maintenance.

Lower carriage assembly 344 also includes a support 360 to which a pair of rails 362 are mounted in a vertical orientation. Profiler heads 346a and 346b are mounted to respective supports 346c and 346d. Supports 346c and 346d are slideably connected to rails 362 by corresponding carriages 364 and connected to respective third actuators 366a, 366b by respective shafts 368. Actuators 366a and 366b are operable to raise and lower the upper profiler head and lower profiler head, respectively, independently of one another.

The configuration of the chipper profiler module 200 thus enables rotation of the chip heads and the profiler heads about respective vertical axes, lateral translation of the chip heads and profiler heads relative to the feed axis, and vertical translation of the profiler heads. The chipper profiler module can be controlled to chip and profile the workpiece (e.g., a log or a cant) along the curvature of the workpiece as the workpiece is transported along the feed axis.

The chipper assemblies and profiler assemblies may function independently to accurately follow the curve of a cant that is being fed through the chipper profiler module. Optionally, the lower carriage assemblies may be rotatable about their respective vertical axes by about 6 degrees in each rotational direction (+ and −). The press rolls of the infeed module may dynamically adjust to any variability of a cant's thickness to maintain the preset clamping force. In addition to following the curvature of the cant, the profiler head assemblies are operable to form the profiles of vertically slewed sideboards along the cant. Preferably the chip heads are conical chip heads (as opposed to drum-style chip heads). The profiling heads may be operable to profile jacket/side boards (e.g., 2×3-inch jacket boards) before of the boards are sawn from the cant by a downstream saw (e.g., saw module 500). This may help to reduce the load at the edger and eliminate complications from conveying and processing flitches. The modular design of the chipper and profiler assemblies may enable them to be easily lifted out for maintenance. A common drive side on the machine may allow for shorter maintenance periods. A reduction in complex motor wiring may also lead to reduced maintenance periods and easier troubleshooting.

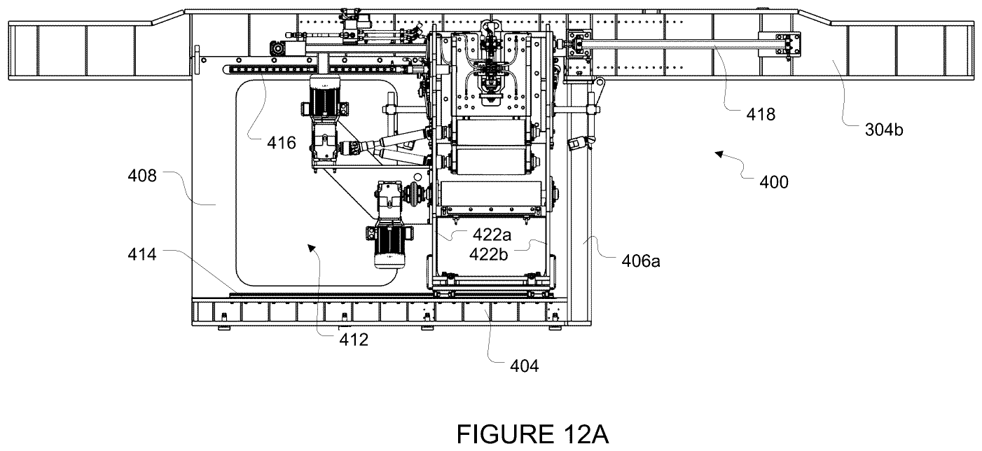

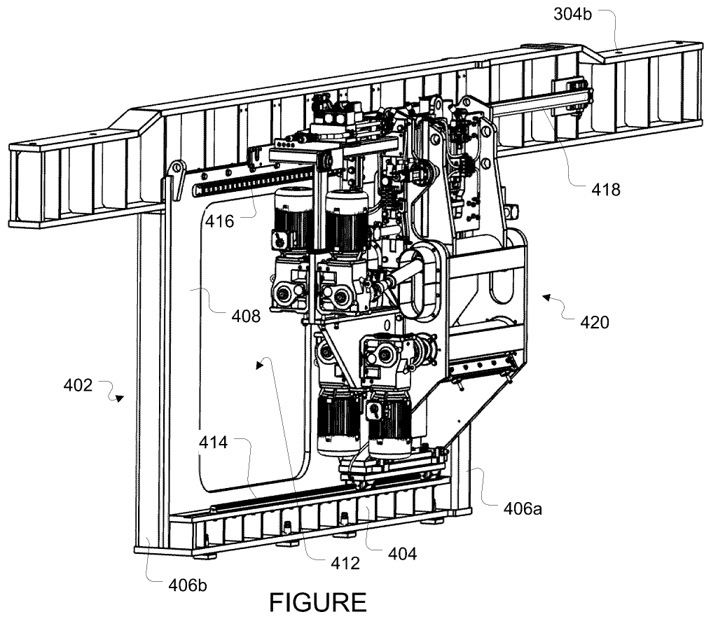

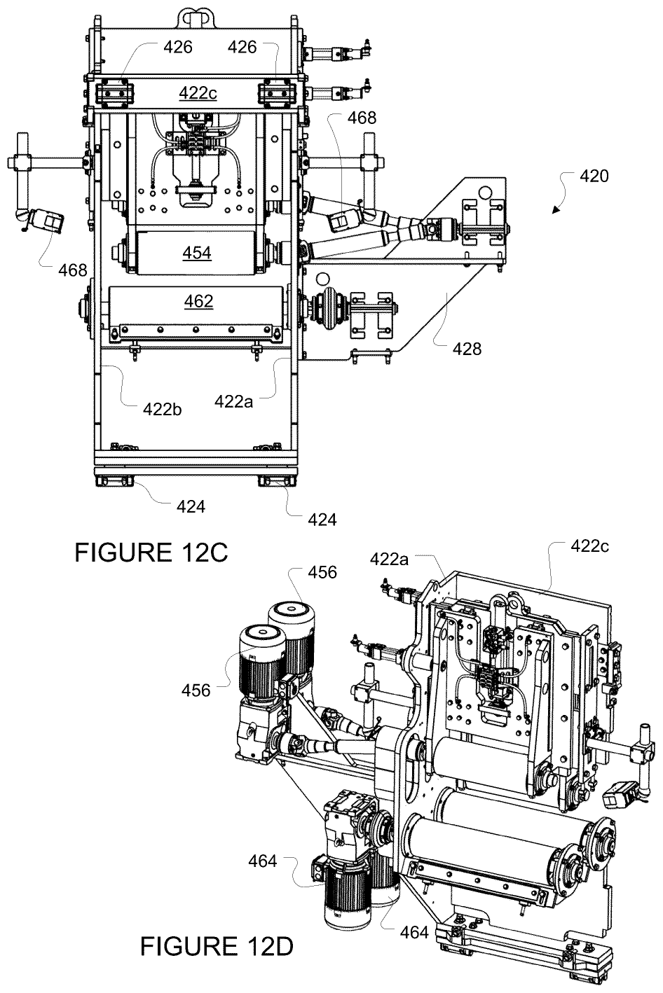

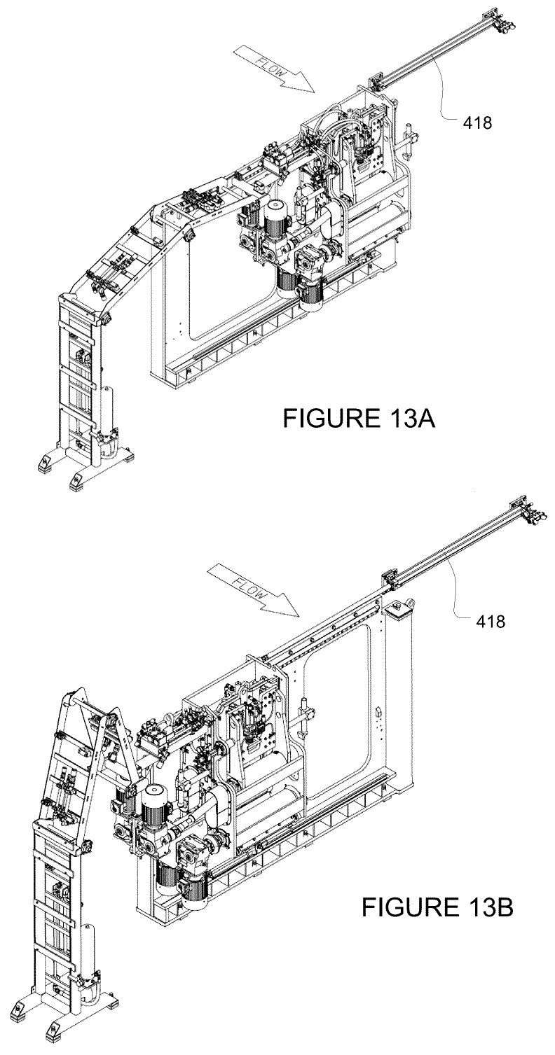

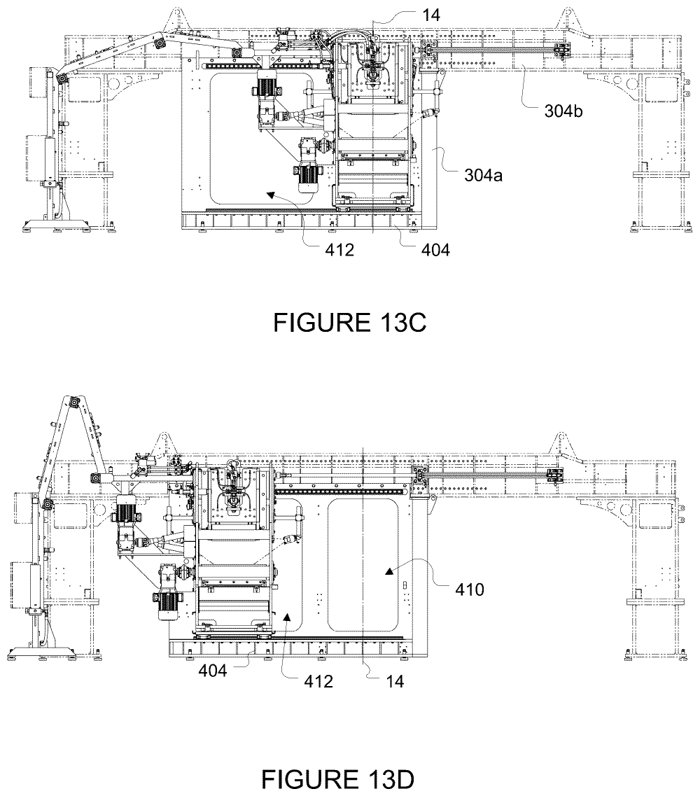

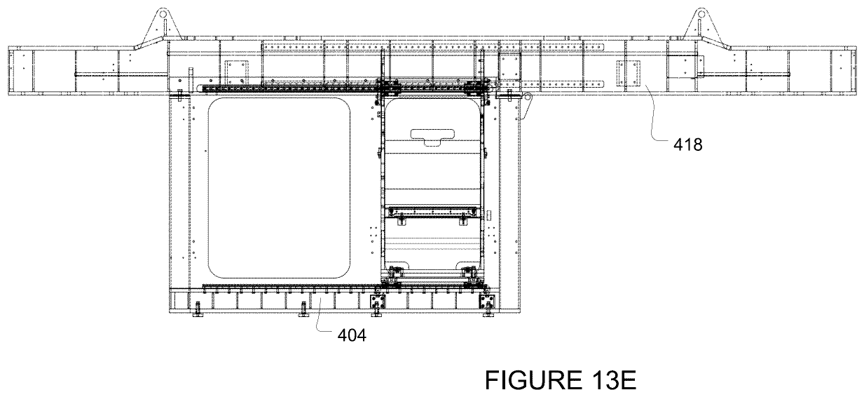

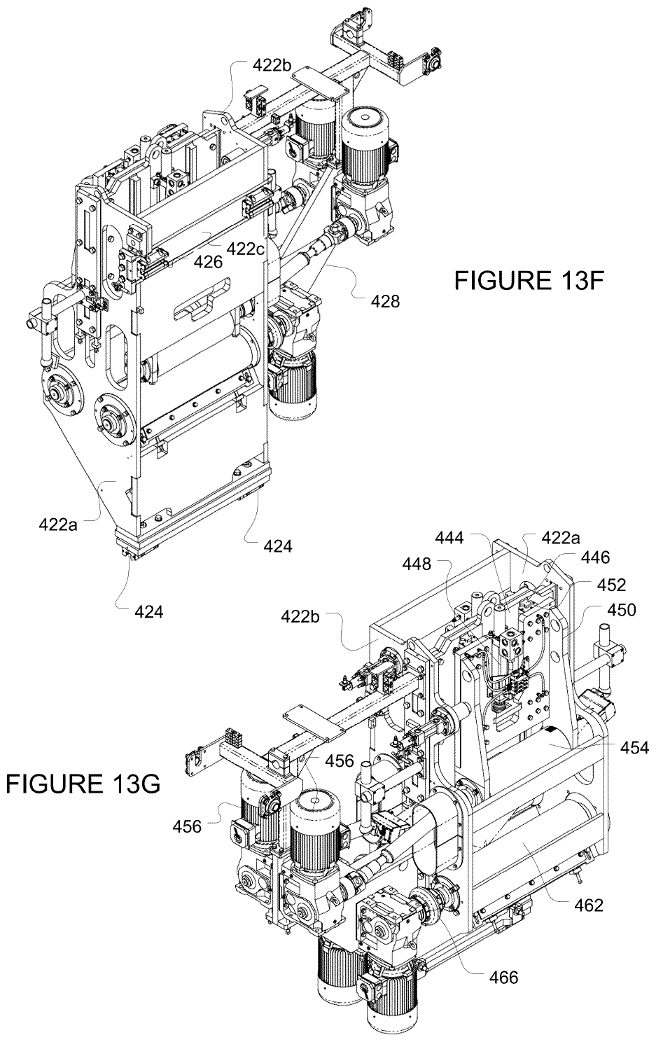

In various embodiments, a mid-feed module may be located between the chipper profiler module and the saw module. An example of a mid-feed module is illustrated in FIGS. 12A-13G.

In the illustrated embodiment, mid-feed module 400 includes a frame 402 and a feed assembly 420 slideably mounted to frame 402. Preferably frame 402 is mounted to the rear/downstream side of second beam 304b of the chipper profile module. However, in other embodiments frame 402 may be free-standing or supported by any suitable means.

Frame 402 includes a base 404 and one or more upright supports that extend from the base 404 to second beam 304b. In the illustrated embodiment, the upright supports include two upright beams 406a and 406b and a plate 408. Plate 408 is mounted to (and connects) second beam 304b, beams 406a and 406b, and base 404. Plate 408 has a first opening 410 and a second opening 412. The first opening 410 is aligned with the feed axis 10, which passes through it. The second opening 412 is located to one side of the feed axis and the first opening 410. A lower rail 414 is mounted on the base 404 and extend below, and transverse to, the feed axis 10. An upper rail 416 is mounted to frame 402 near the top of plate 408 and extends above, and transverse to, the feed axis 10. In the illustrated embodiment rail 416 is mounted to a vertical surface and rails 414 are mounted to a horizontal surface. However, in other embodiments rail 416 may be mounted to a horizontal surface and/or rail 414 may be mounted to a vertical surface. An actuator 418 is mounted to frame 402 and/or to the rear/downstream side of second beam 304b. Actuator 418 is preferably a linear actuator, such as a pneumatic or hydraulic cylinder, but may be any type of actuator suitable for moving feed assembly 420 laterally along rails 414 and 416.

Feed assembly 420 includes a frame, an upper feed member assembly 440, and a lower feed member assembly 460. The frame has opposite side walls 422a and 422b joined by a transverse support 422c, and the feed member assemblies 440 and 460 are mounted to the frame. Carriages 424 are mounted to bottom of the frame and movable along lower rail 414. Carriages 426 are mounted to the transverse support 422c and movable along upper rail 416.

In the illustrated embodiment, upper feed member assembly 440 includes one or more feed roll assemblies. These feed roll assembly(ies) may optionally be the same as, or substantially similar to, feed roll assemblies 222 of infeed module 200 (see e.g., FIG. 6D). As best shown in FIG. 13G, each feed roll assembly has a support plate 444 with rails 446 (e.g., linear bearings), a press frame 450 with rail carriages 452 (e.g., linear bearing carriages), and a feed roll 454. Support plate 444 is mounted to, and extends between, the side walls 422a and 422b. Rails 446 are mounted to support plate 444 in a vertical orientation. Feed roll 454 is rotatably mounted to one side (i.e., upstream side or downstream side) of press frame 450, and rail carriages 452 are mounted to the opposite side of press frame 450 engage the rails 446. This arrangement allows press frames 450 and corresponding feed rolls 454 to be repositioned vertically to accommodate workpieces of different diameters.

Each feed roll assembly of upper feed member assembly 440 may optionally include a corresponding actuator 448 operatively connected to support plate 444 and press frame 450. For example, actuator 448 may be (or may include) a linear actuator, such as a hydraulic or pneumatic cylinder, connected to support plate 444 and press frame 450 and is selectively operable to move press frame 450 vertically relative to support plate 444. Optionally, upper feed member assembly 440 may also include one or more motors 456 operatively coupled with the feed roll(s) 454. Motor(s) 456 may be coupled with the respective feed roll(s) 454 by driveline(s) 458. Optionally driveline 458 may be an extendable and/or flexible driveline with a universal joint.

Lower feed member assembly 460 includes feed rolls 462 rotatably mounted to side walls 422a and 422b of the frame of feed assembly 420. Each of the feed rolls 462 is operatively connected to a respective motor 464 by a coupling 466. Motors 456 and 464 may be mounted to the frame of feed assembly 420. For example, the frame may optionally include a support member 428 that extends outwardly from one of the sides of the frame, and the motors 456 and 464 may be mounted to the support member 428.

Optionally, each motor 456 and/or 464 may have a corresponding reducer (e.g., a right-angle reducer or an inline reducer). Optionally, motors 456 and/or motors 464 may be helical bevel gear motors or another type of gear motor.

Optionally, sensors 468 may be mounted to the side walls 422a and 422b and positioned to detect a cant between upper feed rolls 454 and lower feed rolls 462. Sensors 468 are configured to scan the chipped sides/faces of the cant. For example, a computer system may use the data received from sensors 468 to detect any differences between the expected dimensions and/or geometric profile of the cant (based on a cut solution or cut pattern for the cant) and the actual dimensions and/or geometric profile of the cant (based on the received measurement data). Optionally the computer system continuously compares the measurements to corresponding cut solutions to compare target cant widths to actual cant widths, then calculates cutting errors based on the comparisons, and provides that information to a human operator. The control system may make adjustments to the speed, position, rotational angle, etc. of one or more components of system 100 based on the difference(s). As an example, sensors 468 may optionally be USNR BioLuma sensors, which have a laser profiling resolution of 8 mm (0.3″) and color vision camera resolution of 0.5 mm (0.02″). Alternatively, any other suitable sensors may be used.

The system may continuously or periodically compare the measurements to the cut solution (e.g., determined by one or more optimizers) to identify target versus actual cant widths. It may then calculate cutting errors for the saws or chippers, and may provide this information directly to operators and/or quality control (QC) staff. After scanning enough pieces, the computer system may determine the necessary bias adjustments to offset the difference between the target dimensions (e.g., widths) and the actual dimensions and update the settings for each device, either automatically or with approval from QC staff. Chippers are optionally adjusted symmetrically to maintain optimal performance.

Actuator 418 is actuable to move feed assembly 420 along the rails 414 and 416, relative to frame 402, between an operational position (FIGS. 12A, 12B, 13A, 13C), in which feed assembly 420 is aligned with a vertical centerline 14 of the system 100/first opening 410, such that side walls 422a and 422b are on opposite sides of the feed axis 10, and a maintenance position (FIGS. 13B, 13D) in which feed assembly 420 is located to one side of first opening 410. In the maintenance position, at least some components of feed assembly 420 may be accessible to a human operator through the second opening 412.

When feed assembly 420 and feed assembly 210 (of infeed module 200) are in the maintenance position, and movable platform 264 is in the support position, the cutting tools, guides, and other components of the chipper profiler module 300 and saw module 500 are accessible to a human operator standing on the support surface formed by fixed platform 262 and movable platform 264.

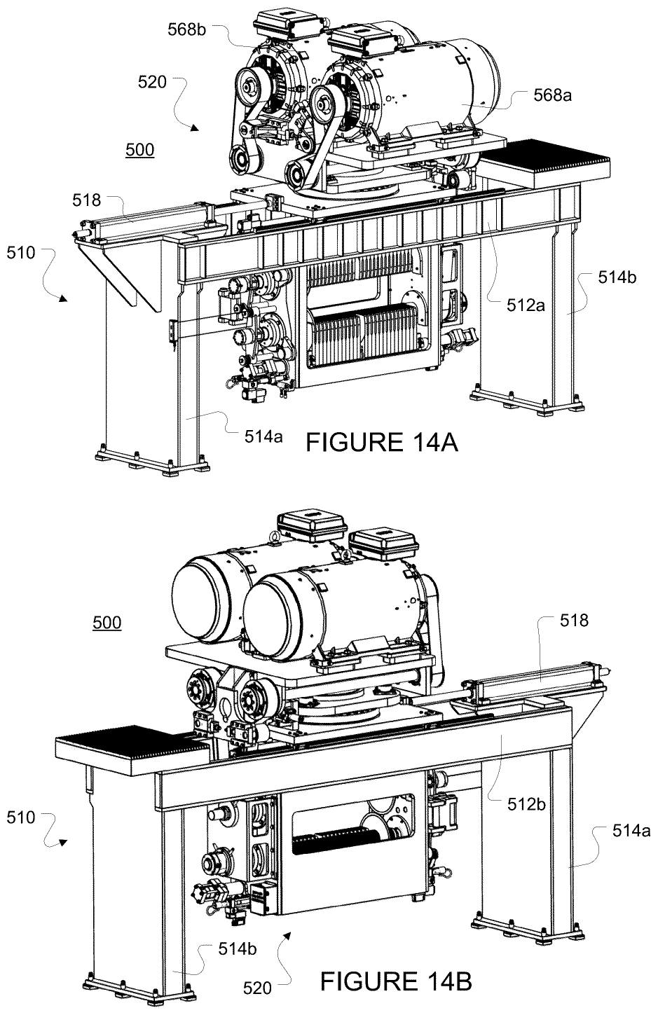

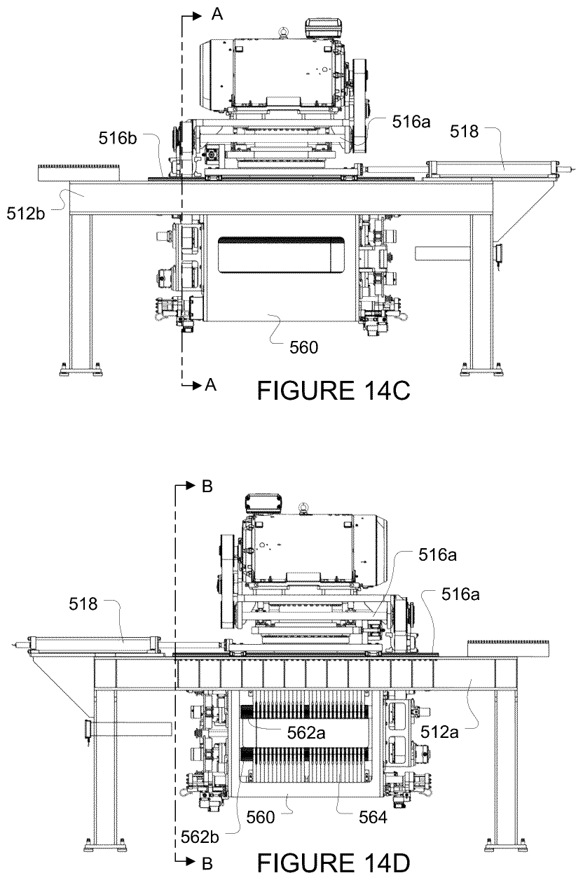

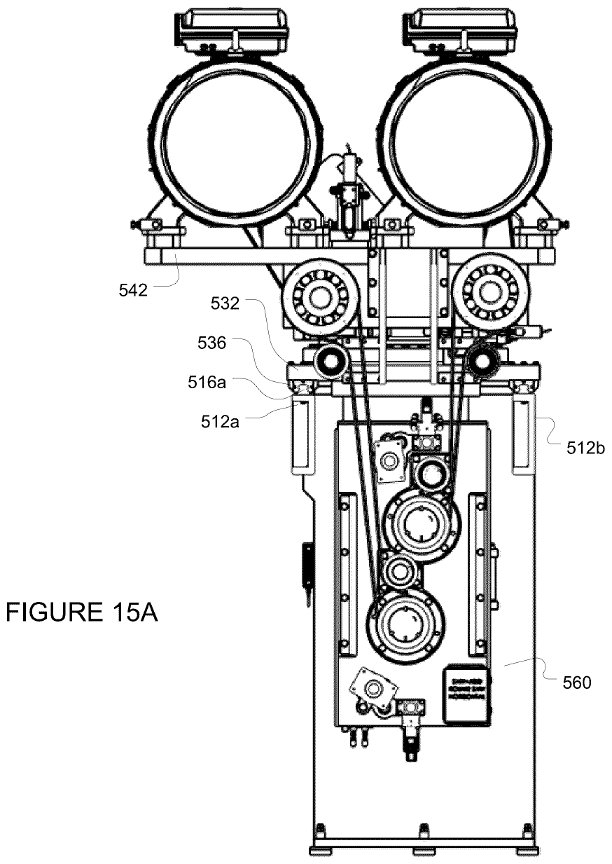

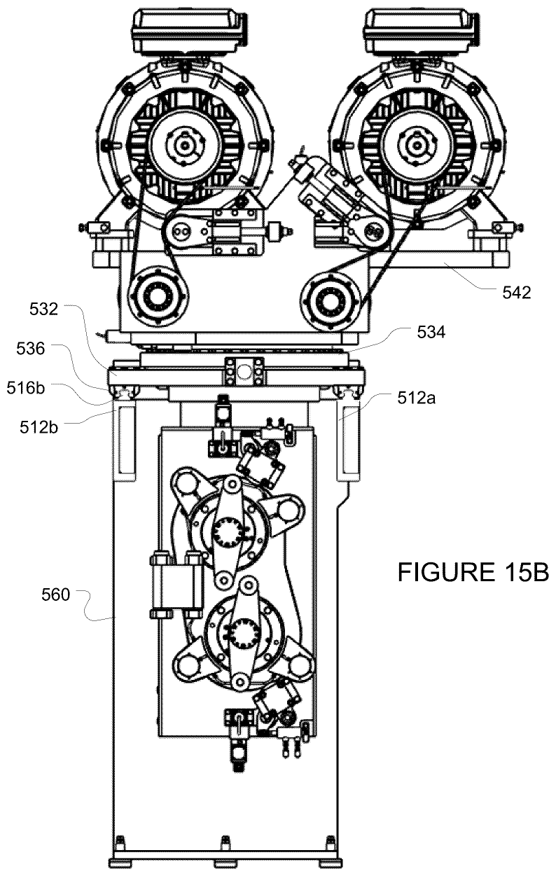

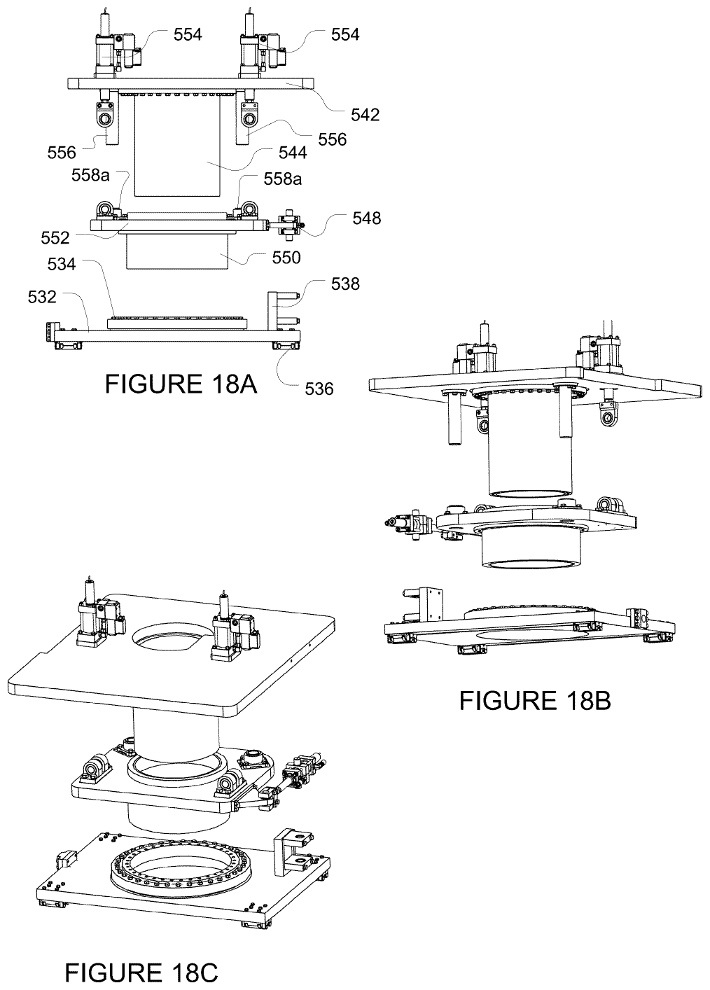

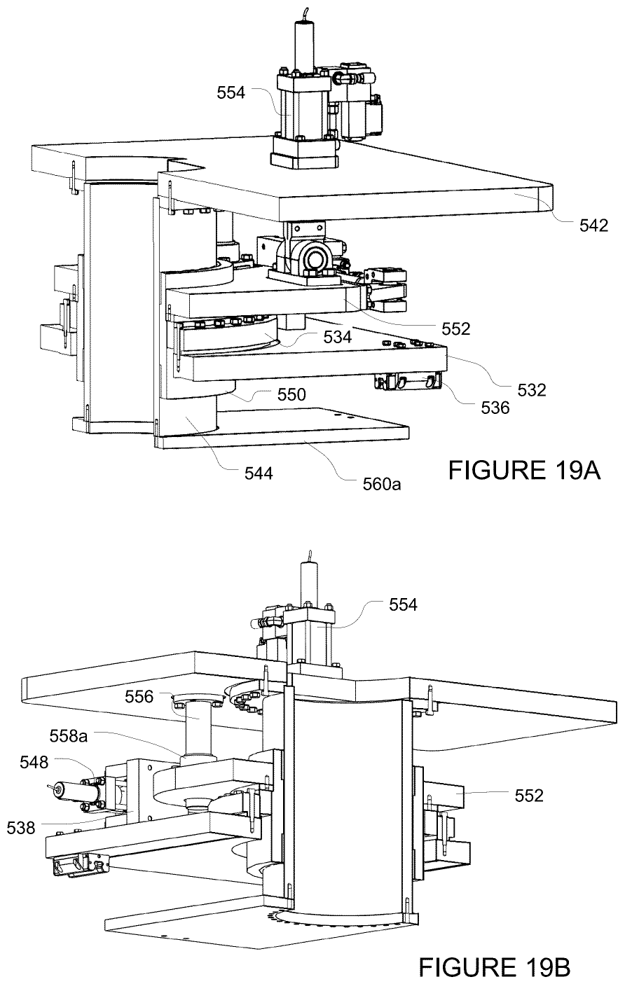

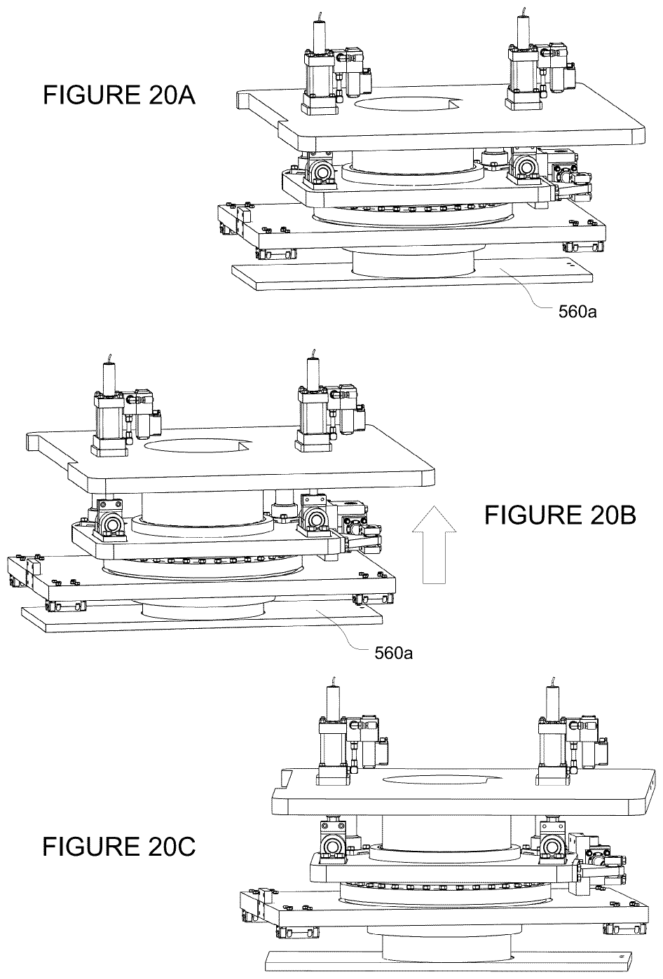

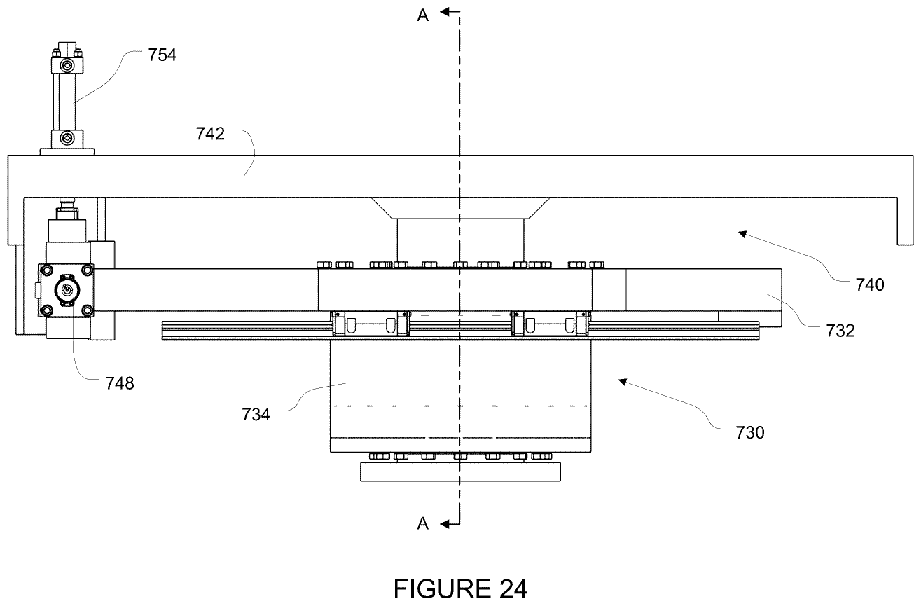

Referring now to FIGS. 14A to 25B, saw module 500 includes a frame 510 and a saw assembly 520 movably mounted to frame 510.

Frame 510 includes a pair of horizontal beams 512a and 512b that are disposed above, and transverse to, the feed axis 10 and spaced apart along the feed direction. Beams 512a and 512b are supported by at least one pair of upright supports 514a and 514b disposed on opposite sides of the feed axis 10.

Saw assembly 520 includes a first support assembly 530, a second support assembly 540, and a saw box 560.

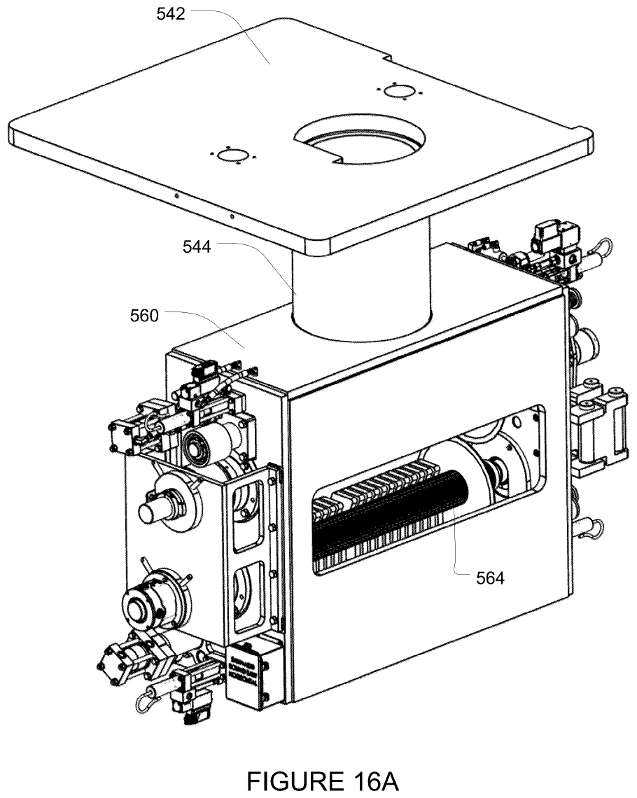

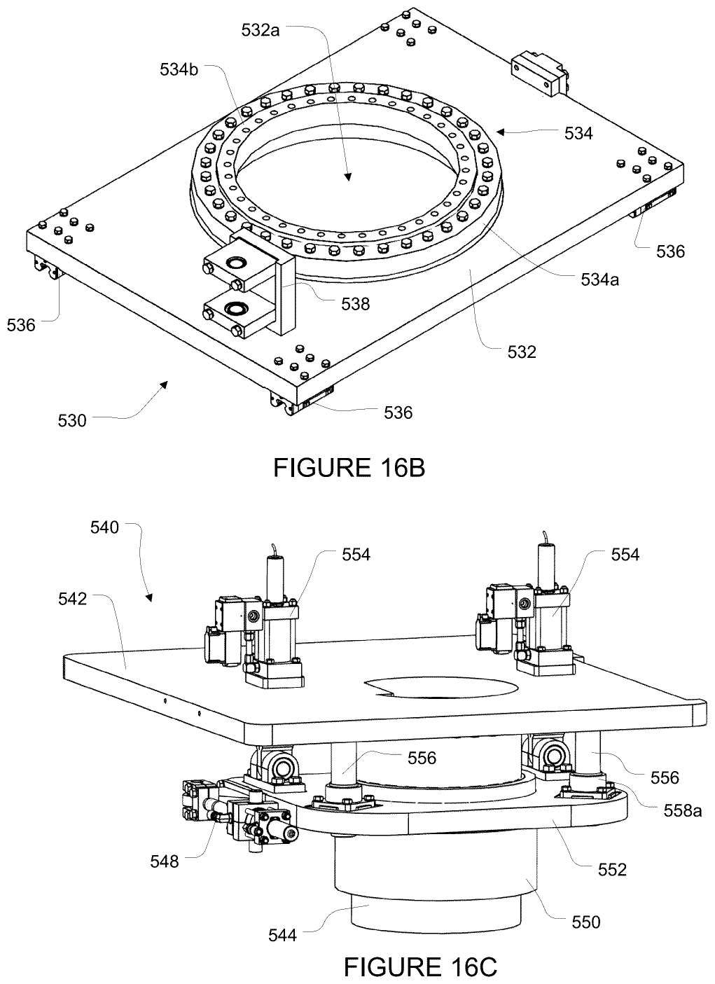

First support assembly 530 (see FIG. 16B) includes a first platform 532 and a ring bearing 534 mounted to a top face of the first platform. Ring bearing 534 is aligned with an opening 532a in first platform 532. Ring bearing 534 has an outer ring 534a and an inner ring 534b that is rotatable relative to outer ring 534a (FIG. 16B). Outer ring 534a is fixedly mounted to first platform 532. Optionally first support assembly 530 further includes an actuator mount 538 configured to mount a first actuator (discussed below) to first platform 532.

First platform 532 may be supported on, and slideably mounted to, the beams 512a, 512b by any suitable means. In the illustrated example, rails 516a and 516b are mounted on beams 512a and 512b, respectively, extending above and transverse to feed axis 10. Carriages 536 are mounted to a bottom face of the first platform, and are in sliding engagement with the rails 516a and 516b. Alternatively, the rails 516a and 516b and carriages 536 may be omitted, and the first platform 532 may be supported on, and slideably mounted to, the beams by other means.

Second support assembly 540 is supported by, and pivotably coupled to, first support assembly 530 (see e.g., FIG. 16C). In the first embodiment shown in FIGS. 14A-20C, second support assembly 540 includes a second platform 542, which is disposed above the first platform 532, and a cylinder 544 that extends vertically through first support assembly 530 and between beams 512a and 512b. A first end of cylinder 544 is fixedly coupled to second platform 542. An opposite second end of cylinder 544 is fixed coupled to saw box 560 (e.g., to a top 560a of the saw box), such that saw box 560 is supported by second support assembly 540 and disposed below the beams 512a and 512b. As second support assembly 540 is supported by first support assembly 530, and first support assembly is supported by beams 512a and 512b, saw box 560 is effectively suspended from beams 512a and 512b.

First support assembly 530 is movable (along rails 516a and 516b), relative to beams 512a and 512a, in opposite directions along a horizontal path that is above and transverse to the feed direction 12 to thereby move saw box 560 (and second saw assembly 540) laterally relative to the feed axis 10. Optionally, an actuator 518 (FIGS. 14A-14D) may be mounted to frame 510 and connected to first platform 532. Actuator 518 may be a linear actuator (e.g., a pneumatic or hydraulic cylinder) that is operable to apply lateral force against first platform 532 to thereby move the support assemblies and saw box in opposite directions along the rails 516a and 516b.

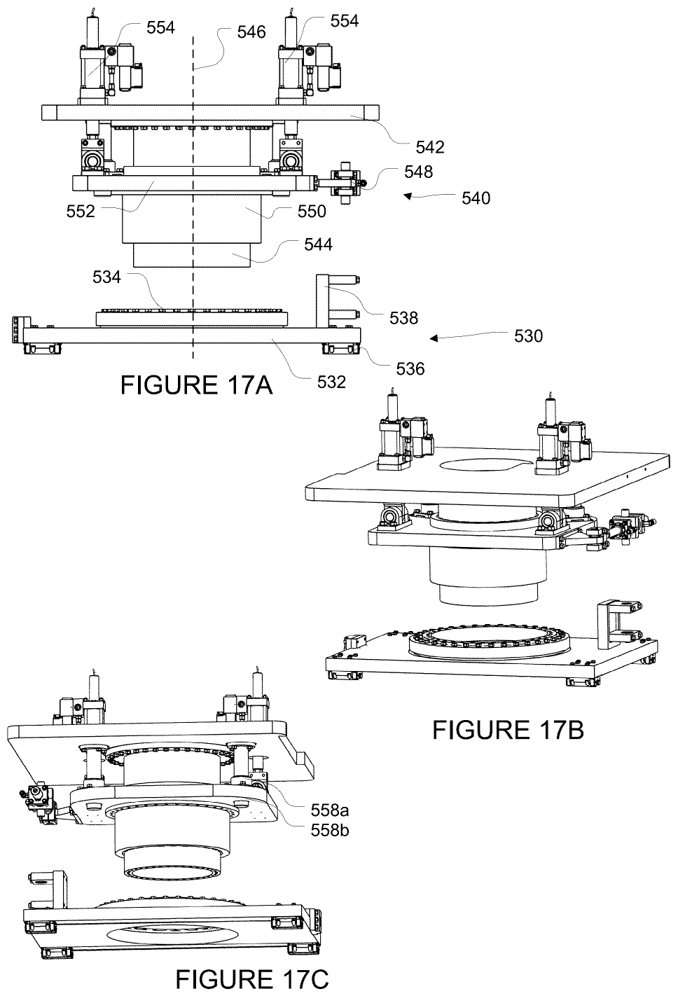

Second support assembly 540 is pivotable, relative to first support assembly 530, about a vertical axis 546 (FIG. 17A) that passes through the center of cylinder 544 to thereby pivot saw box 560 about the vertical axis 546. Second platform 542 and cylinder 544 are vertically movable, relative to first support assembly 530, to thereby raise and lower saw box 560.

In the first embodiment shown in FIGS. 14A-20C, second support assembly 540 further includes a third platform 552 and a cylindrical tube 550. Third platform 552 is disposed between first platform 532 and second platform 542. Cylindrical tube 550 extends through, and is fixedly mounted to, third platform 548 (see FIG. 16C). Inner ring 534b is fixedly mounted to the lower end of cylindrical tube 550. Cylinder 544 extends vertically through the interior of cylindrical tube 550.

A first actuator 548 is mounted to first platform 532 and connected to third platform 552. First actuator 548 is selectively actuable to apply lateral pressure against a portion of third platform 552 to pivot third platform 552 about the vertical axis 546, which causes second support assembly 540 and saw box 560 around the vertical axis 546 relative to first platform 532.

Second support assembly 540 further includes at least one second actuator 554 that is mounted to second platform 542 and connected to third platform 552. While first actuator 548 is positioned to exert lateral force, second actuator 554 is positioned to exert vertical force. Second actuator 554 is actuable to raise and lower second platform 542 relative to third platform 552 to thereby raise and lower saw box 560 relative to the feed axis 10. First and second actuators 548 and 554 may be linear actuators, such as pneumatic or hydraulic cylinders. Optionally one or more lift guides 556 (e.g., cylinders or shafts) may be mounted to the underside of second platform 542 in axial alignment with one or more corresponding features (e.g., bushings 558a and/or through-holes 558b) configured to receive or engage the lift guide(s) 556.

Saw assembly 520 may optionally include an upper arbor 562a and a lower arbor 562b mounted to, and extending between, the opposite sides of saw box 560. Circular saw blades 566 may be mounted to the arbors and guided by corresponding saw guides 564. The arbors 562a and 562b are operatively coupled to respective motors 568a and 568b, which are mounted to (and supported on) second platform 542. In the embodiment shown in FIGS. 14A-20C, shafts 570a and 570b are rotatably mounted to second platform 542, below the underside of the second platform. Each of the motors 568a and 568b is connected to a first end of a corresponding one of the shafts by a belt, and the opposite second end of each shaft is connected to a corresponding one of the arbors by another belt. Alternatively, motors 568a and 568b may be coupled to the respective arbors in any other suitable manner. Motors 568a and 568b are operable to drive the arbors, and the circular saw blades arrayed along the arbors, in rotation during sawing operations.

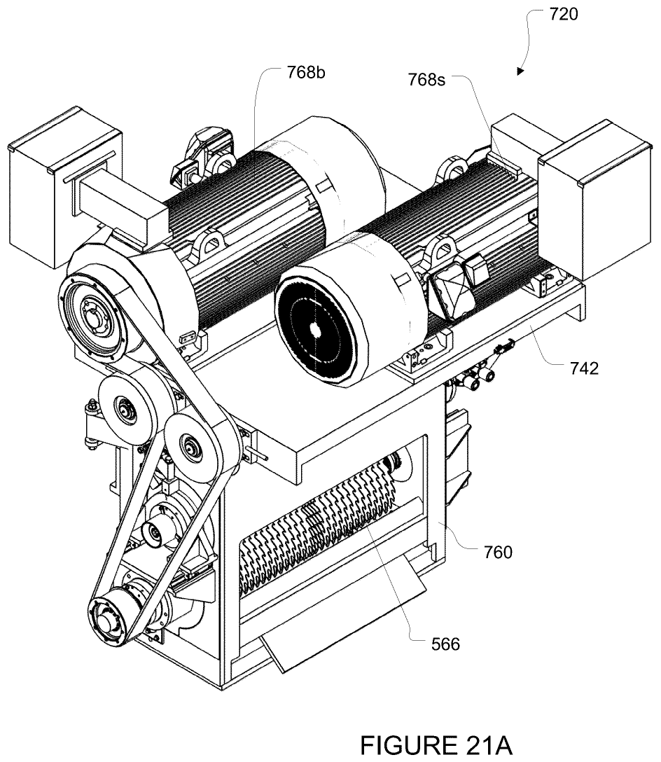

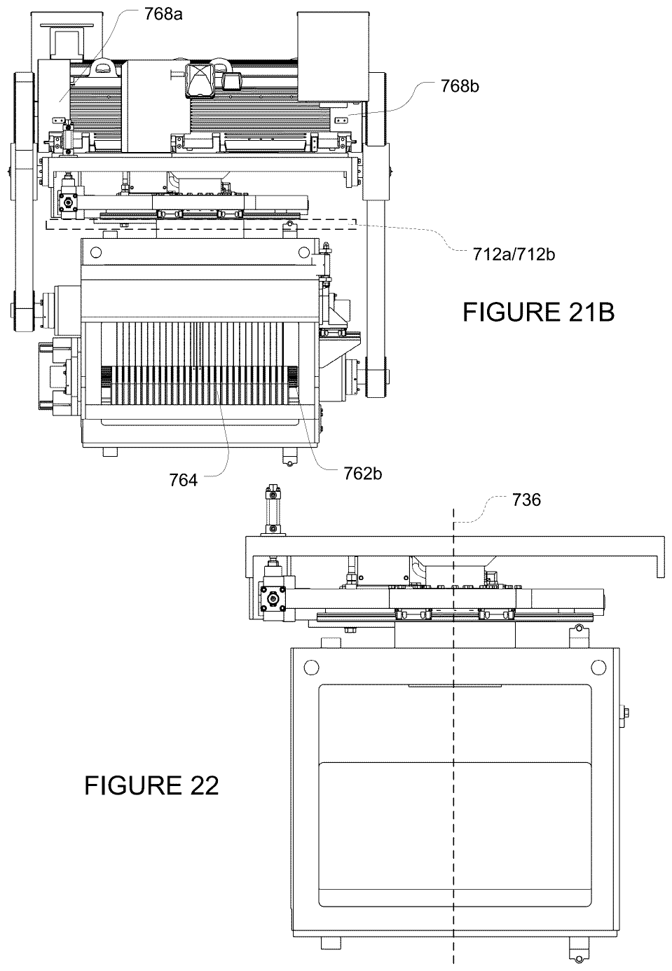

A second embodiment of a saw assembly is shown in FIGS. 21A-25B. In this embodiment, saw assembly 720 is configured to be movably mounted to a frame (not shown) that includes one or more horizontal beams 712a and 712b (show in phantom in FIG. 21B) disposed above, and transverse to, the feed axis. For example, saw assembly 720 may be mounted to frame 510 or any other suitable frame.

Saw assembly 720 includes a first support assembly 730, a second support assembly 740, and a saw box 760.

First support assembly 730 (see FIG. 16B) includes a first platform 732 and a cylinder housing 734 mounted to a top face of the first platform 732. In this embodiment, cylinder housing 734 includes a cylinder housing top 734a, a cylinder housing barrel 734b, and a cylinder housing bottom 734c. Cylinder housing top 734a is fixedly mounted to an upper end of cylinder housing barrel 734b and to first platform 732. Cylinder housing bottom 734c is fixedly mounted to the bottom end of cylinder housing barrel 734b. Cylinder housing top, barrel, and bottom 734a, 734b, and 734c are in vertical axial alignment with one another and with an opening in first platform 732. Cylinder housing 734 has an interior bore 734d.

First platform 732 may be supported on, and slideably mounted to, the beams 712a, 712b by any suitable means. In the illustrated example, rails 716a and 716b are mounted on beams 712a and 712b, respectively, extending above and transverse to feed axis 10. Carriages 736 are mounted to a bottom face of the first platform, and are in sliding engagement with rails 716a and 716b. Alternatively, the rails 716a and 716b and carriages 736 may be omitted, and the first platform 732 may be supported on, and slideably mounted to, the beams by other means.

Second support assembly 740 is supported by, and pivotably coupled to, first support assembly 730. In this embodiment, second support assembly 740 includes a second platform 742, which is disposed above the first platform 732, and a cylinder 744 that extends vertically through first support assembly 730 and between beams 712a and 712b. A first end of cylinder 744 is fixedly coupled to second platform 742. An opposite second end of cylinder 744 is fixedly coupled to saw box 760 (e.g., to a top of the saw box), such that saw box 760 is supported by second support assembly 740 and disposed below the beams 712a and 712b. As second support assembly 740 is supported by first support assembly 730, and first support assembly is supported by beams 712a and 712b, saw box 760 is effectively suspended from beams 712a and 712b.

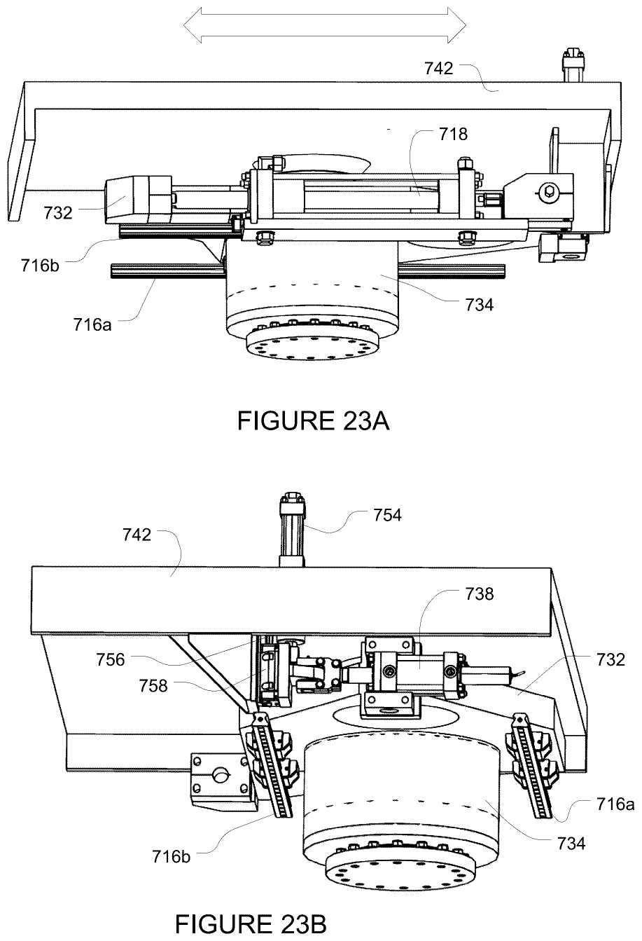

First support assembly 730 is movable (along rails 716a and 716b), relative to beams 712a and 712a, in opposite directions along a horizontal path that is above and transverse to the feed direction 12 to thereby move saw box 760 (and second saw assembly 740) laterally relative to the feed axis 10. Optionally, an actuator 718 (FIG. 23A) may be mounted to the frame and connected to first platform 732. Actuator 718 may be a linear actuator (e.g., a pneumatic or hydraulic cylinder) that is operable to apply lateral force against first platform 732 to thereby move the support assemblies and saw box in opposite directions along the rails 716a and 716b.

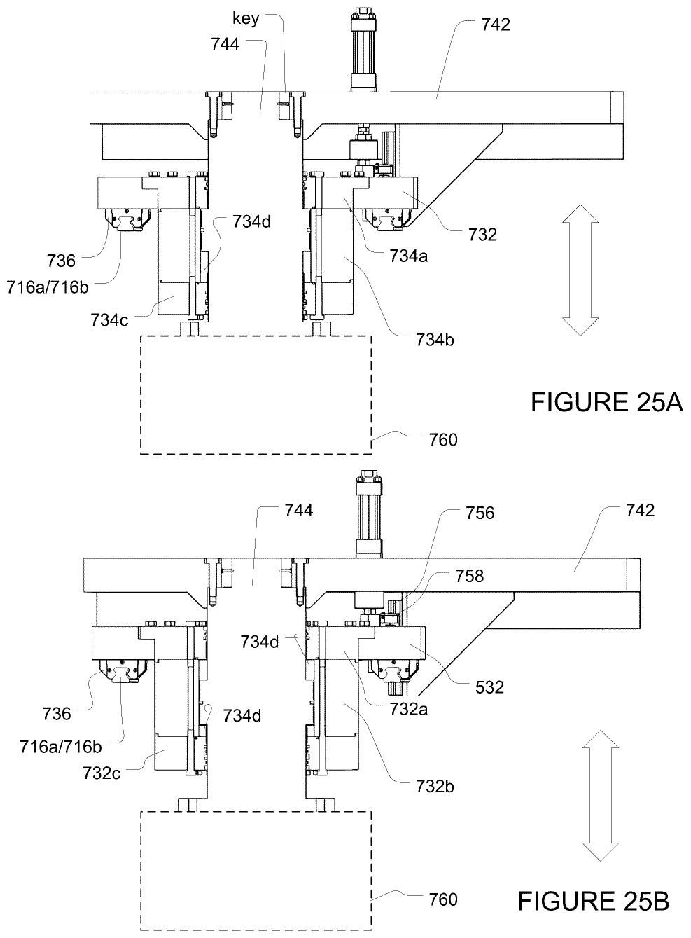

Second support assembly 740 is pivotable, relative to first support assembly 730, about a vertical axis 746 (FIG. 22) that passes through the center of cylinder 744 to thereby pivot saw box 760 about the vertical axis 746. Second platform 742 and cylinder 744 are vertically movable, relative to first support assembly 730, to thereby raise and lower saw box 760 (see e.g., FIGS. 25a and 25B).

A first actuator 748 is mounted to first platform 732 and connected to second platform 742. First actuator 748 is selectively actuable to apply lateral pressure against a portion of second platform 742 to pivot second platform 742 about the vertical axis 746, which causes second support assembly 740 and saw box 760 around the vertical axis 746 relative to first platform 732.

Second support assembly 740 further includes at least one second actuator 754 that is mounted to second platform 742 and connected to first platform 732. While first actuator 748 is positioned to exert lateral force, second actuator 754 is positioned to exert vertical force. Second actuator 754 is actuable to raise and lower second platform 742 relative to first platform 752 to thereby raise and lower saw box 760 relative to the feed axis 10. First and second actuators 748 and 754 may be linear actuators, such as pneumatic or hydraulic cylinders. Optionally a lift guide 756 (e.g., a linear bearing/rail) may be mounted to the underside of second platform 742 and engaged by a corresponding feature (e.g., a carriage 758) configured to receive or engage the lift guide 756.

Saw assembly 720 may optionally include an upper arbor (not shown) and a lower arbor 762b mounted to, and extending between, the opposite sides of saw box 760. Circular saw blades 566 may be mounted to the arbors and guided by corresponding saw guides 764. The upper and lower arbors are operatively coupled to respective motors 768a and 768b, which are mounted to (and supported on) second platform 742. In the embodiment shown in FIGS. 21A-25B, each of the motors 768a and 768b is connected to a corresponding one of the arbors by a respective belt, and the belts are on opposite sides of saw box 760. Alternatively, motors 768a and 768b may be coupled to the respective arbors in any other suitable manner.

Therefore, in the above-described embodiments of the saw assembly, the saw box is movable vertically and laterally, and rotatable about a vertical pivot axis, during operation of the saw module. The lateral and pivoting mobility allows the saw box to follow the curvature of a cant while cutting the cant into boards. The vertical mobility allows the saw box to be raised and lowered based on the height of an incoming cant, to distribute the depth of cut evenly among the saw blades along the upper arbor and the saw blades along the bottom arbor. Distributing the depth of cut evenly between the upper and lower arbors can increase throughput speed through the saw module. For example, adjusting the saw box vertically to balance the depths of cut evenly between bottom and top arbors may allow the saw module to process cants up to 8-inches thick at the same speed as smaller cants.

Optionally the saw module features fully automatic saw mismatch adjusted via setworks. This also enables arbor wear adjustments to be made automatically. Auto-mismatch allows the top and bottom saws to have a pre-set bias, which extends the time between calibrations.

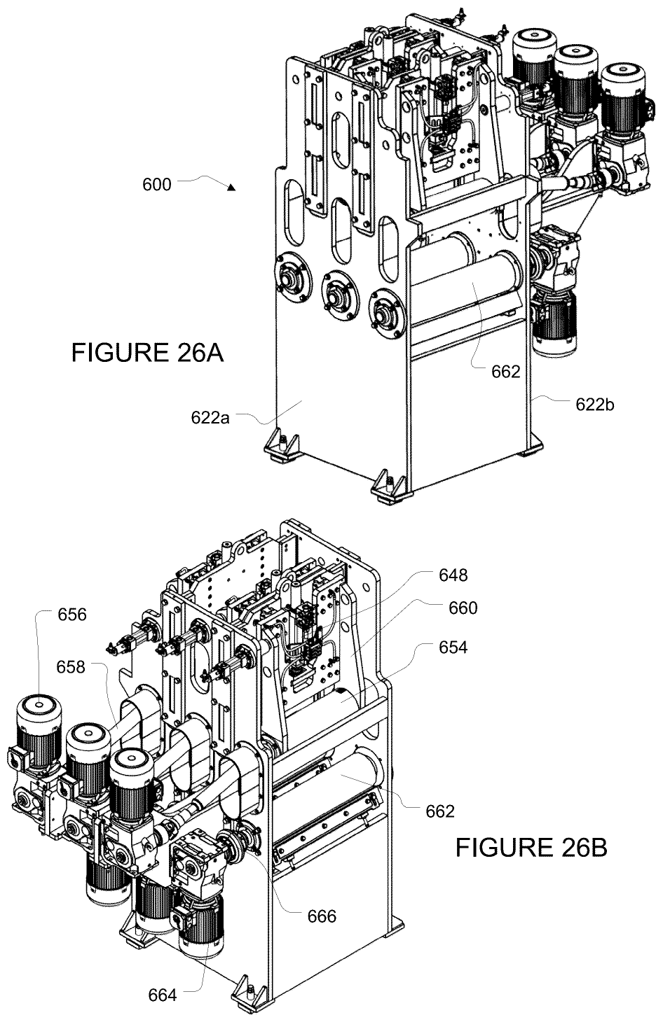

In various embodiments, outfeed module 600 may include a frame, an upper feed member assembly, and a lower feed member assembly. The frame has opposite side walls 622a and 622b, and the feed member assemblies are mounted to the frame (FIGS. 26A and 26B). While the frame of the outfeed module is stationary in this embodiment, in other embodiments the upper and lower feed assemblies and/or the frame 402 may be slideably mounted to a base and/or an upright support, similar to infeed module 200 and/or mid-feed module 400. In that case, the feed member assemblies (and optionally the frame) may be movable laterally, away from the feed axis, to access the saw assembly or other components.

Referring again to FIGS. 26A and 26B, the upper feed member assembly includes one or more feed roll assemblies. Again, these feed roll assembly(ies) may optionally be the same as, or substantially similar to, feed roll assemblies 222 of infeed module 200 (see e.g., FIG. 6D). While the illustrated embodiment includes three such feed roll assemblies, other embodiments may have fewer than three or more than three of those assemblies. The press frames 660 of these feed roll assemblies and the corresponding upper feed rolls 654 are vertically movable, as described above with regard to feed roll assemblies 222, allowing them to be repositioned vertically to accommodate workpieces of different diameters.

Each feed roll assembly of the upper feed member assembly may optionally include a corresponding actuator 648. Actuator 648 may be (or may include) a linear actuator, such as a hydraulic or pneumatic cylinder, that is selectively operable to move press frame 650 vertically. Optionally, the upper feed member assembly may also include one or more motors 656 operatively coupled with the feed roll(s) 654. Motor(s) 656 may be coupled with the respective feed roll(s) 654 by driveline(s) 658. Optionally driveline 658 may be an extendable and/or flexible driveline with a universal joint.

The lower feed member assembly may have the same or similar configuration and features as lower feed member assembly 460 of mid-feed module 400. In the illustrated embodiment, the lower feed member assembly includes feed rolls 662 rotatably mounted to side walls 622a and 622b. Each of the feed rolls 662 is operatively connected to a respective motor 664 by a coupling 666. Motors 656 and 664 may be mounted to the frame of outfeed module 600.

Optionally, each motor 656 and/or 664 may have a corresponding reducer (e.g., a right-angle reducer or an inline reducer). Optionally, motors 656 and/or motors 664 may be helical bevel gear motors or another type of gear motor.

Other embodiments of the system may have feed modules of different configurations than those described above. Again, some embodiments may include only one of the cutting modules (chipper profiler module or saw module) and/or lack feed modules. Preferably, an area below the chip heads and the profiler heads and an area below the saw box are open or have respective waste conveyors.

Optionally the infeed, mid-feed, and outfeed modules all feature feed rolls driven either by coupled gearboxes or drivelines, and no serpentine chain or belt is used anywhere in the system. This may further reduce maintenance costs and downtime. Infeed chain and press rolls are configured to hold the cant stable while feeding into the system. Preferably the press rolls are all hydraulic and feature position and force control which improves overall contact with the workpieces. This ensures that cants are secured against the bed rolls with a consistent pressure, improving lumber quality. Optionally all upper feed rolls are provided as part of quick-change assemblies of the same design (e.g., feed roll assemblies 222) making them easy to service and maintain and allowing for common spare assemblies. Quick-change press roll and bed roll assemblies allow for spare assemblies to be inserted while the damaged or worn assemblies are removed for maintenance offline. The ability to do maintenance offline may decrease downtime and increase the overall reliability of the system. Optionally, the upper feed rolls are configured to dynamically adjust to any variability of a cant's thickness to maintain the preset clamping force.

Optionally, some or all of the motors of system 100 are F3 IEC motors, eliminating left-right J-box configurations. A common drive side on the modules allows for shorter maintenance periods. The reduction in complex motor wiring also contributes to simplified troubleshooting.

Optionally, system 100 may further include a computer system operatively coupled with one or more (or all) of the cutting/feed modules. The computer system may perform optimization and control functions. The computer system may fully support curve sawing and allow different products with varying values, targets, and wane rules to be placed in specific areas of the cant. Surface feature recognition allows cant characteristics to classify user-definable grades. The computer system may automate size control for gang saws by scanning each cant both before and after chipping. It may calculate width error trends and automatically adjust chipper bias by writing corrections to the PLC of the computer system, ensuring precise control over width errors. The computer system may be configured to control hydraulic force applied by the upper feed rolls of the feed modules to hold workpieces securely against the lower feed members without causing the workpieces to warp under pressure. This may help to maintain better control of the upper feed rolls, ensuring more contact with the workpiece when moving over bumps or dips. Better cant control may result in better quality boards at the outfeed.

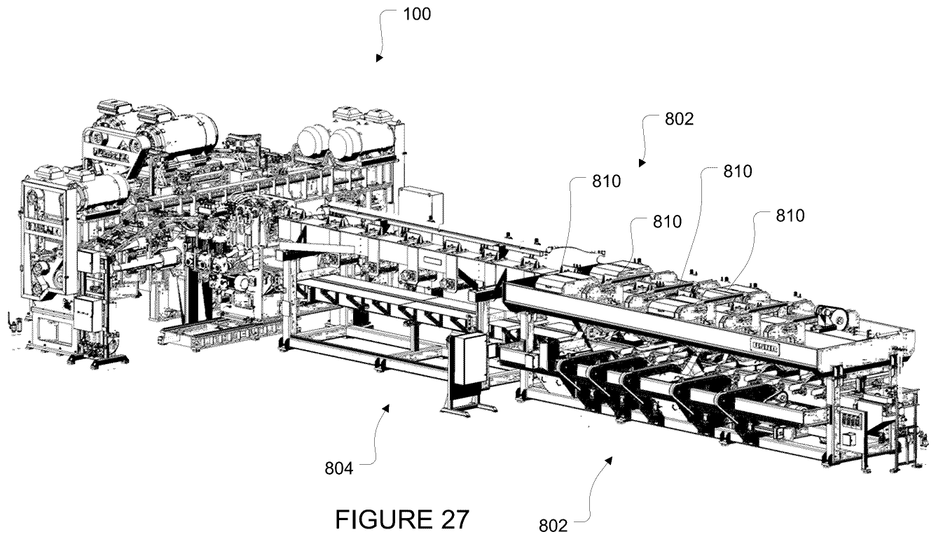

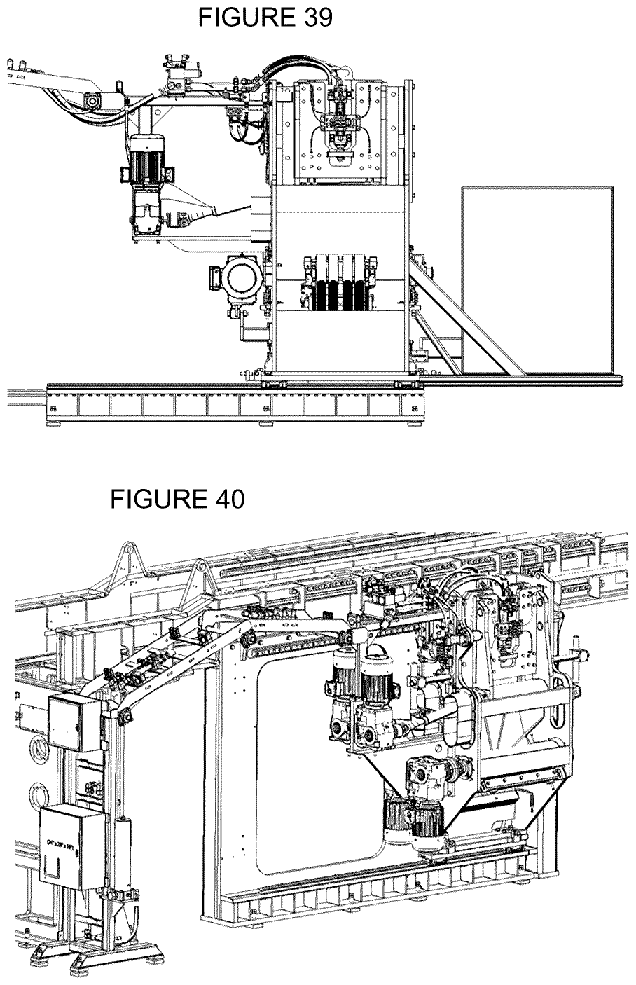

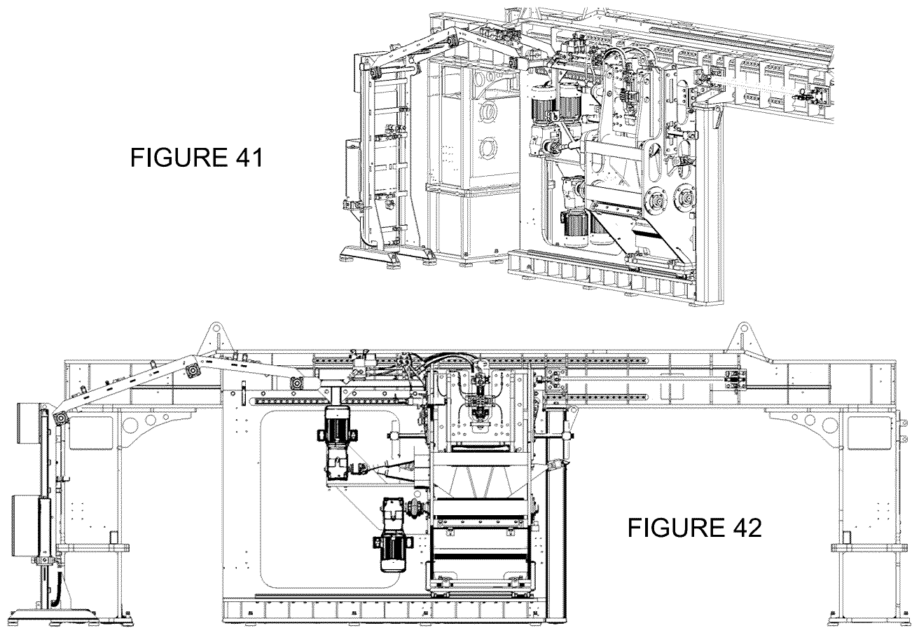

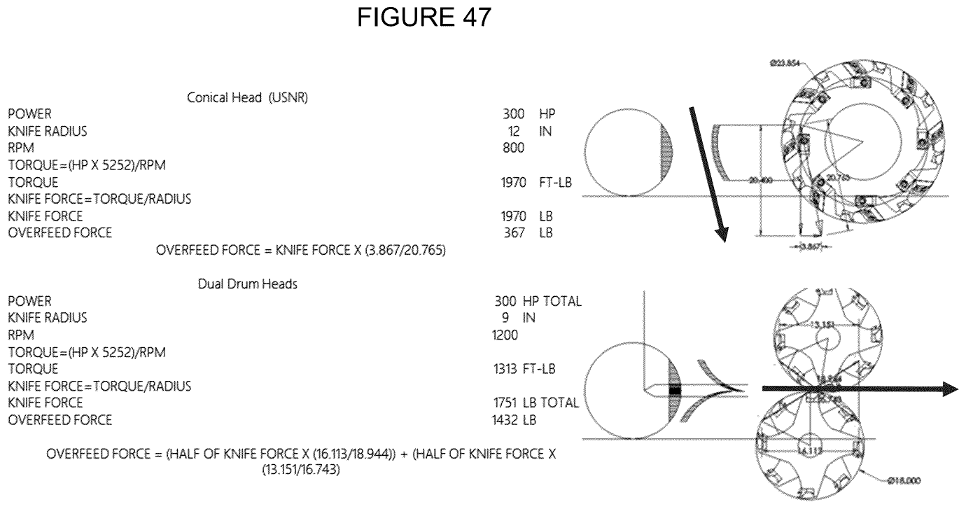

Additional views of system 100 are shown by way of example in FIGS. 27-62. Unless otherwise stated, the system 100, its modules, and all of the components thereof are as described above.

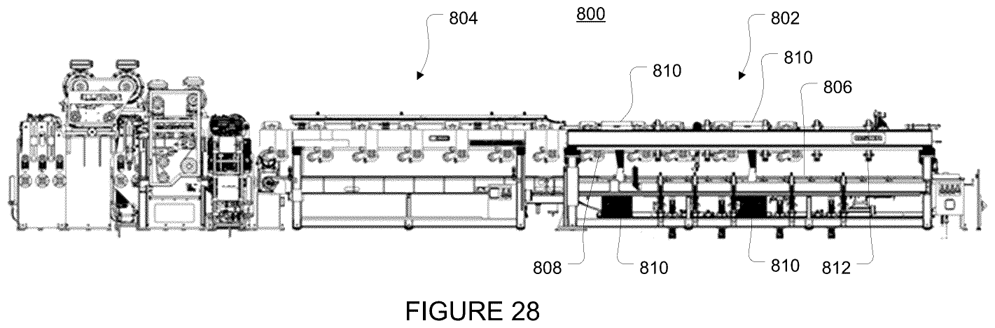

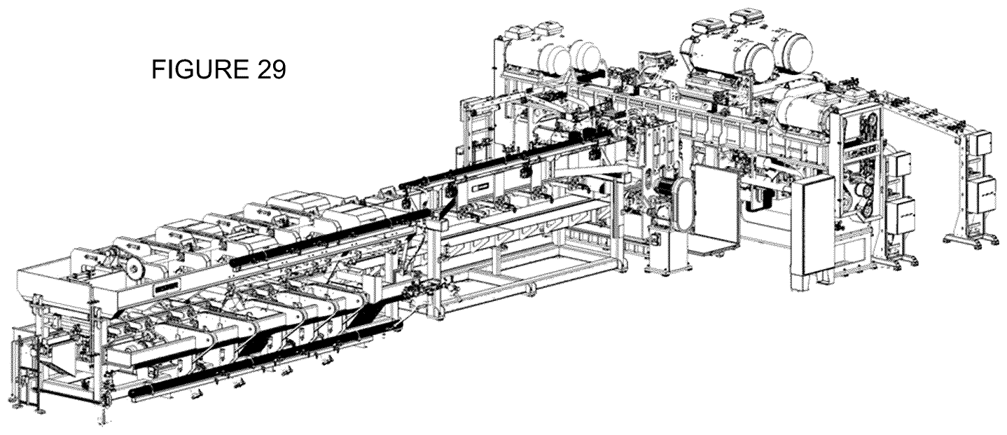

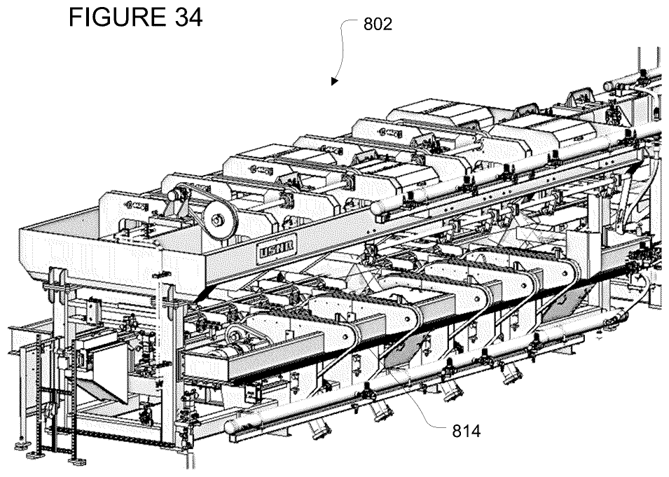

Optionally, in some embodiments system 100 may further include one or more additional feed modules. For example, system 100 may optionally include an additional infeed configured to convey workpieces to infeed module 200. An example of such a system is shown in FIGS. 27 and 29 (perspective views) and FIG. 28 (side elevational view). In this example, the additional infeed is a centering infeed system 800 located upstream of the infeed module 200. The centering infeed system preferably has a short lineal footprint that may accommodate up to three scan zones and can be fed from either the left, the right, or both sides. It may operate at speeds up to 650 feet per minute (about 200 meters per minute), which may be faster than the gang itself, such that the centering infeed 800 is not a choke point in production. In this embodiment, centering infeed 800 includes a centering table 802 and a bridge portion 804 that extends from the table portion 802 toward the infeed module 200. The centering table 802 of the centering infeed 800 is configured to center a cant to the feed axis and to then secure it against the sharp-top chain 806 using overhead press rolls 808. For example, centering table 802 may have feed belts/chains 814 that extend transverse to the sharp-top chain along one or both sides thereof to move cants toward the sharp-top chain and to aid in centering the cant along the feed axis (see FIG. 34). Cants then travel lineally through the scan zones (i.e., through the fields of view of scanners 810 disposed along upper and/or lower portions of the frame of the centering table), and the optimal solution is determined while the cant travels down the bridge portion 804. This bridge portion 804 can optionally vary in length to fit an existing mill. An overhead antiroll shoe 812 may optionally be mounted to the upper portion of the frame of the centering table 802 to prevent cants from rolling when entering the centering table 802. Optionally, the centering table 802 may be a USNR Quickscan Table.

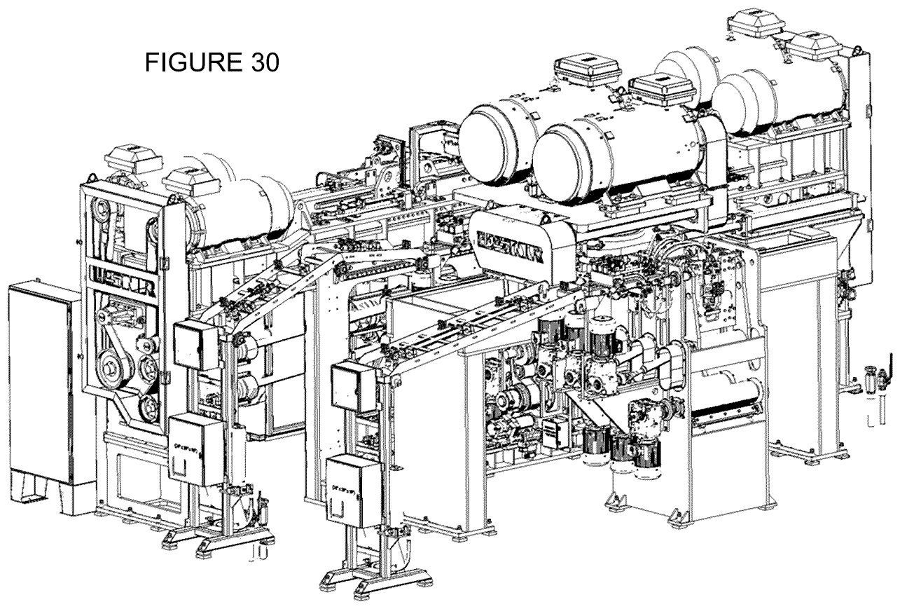

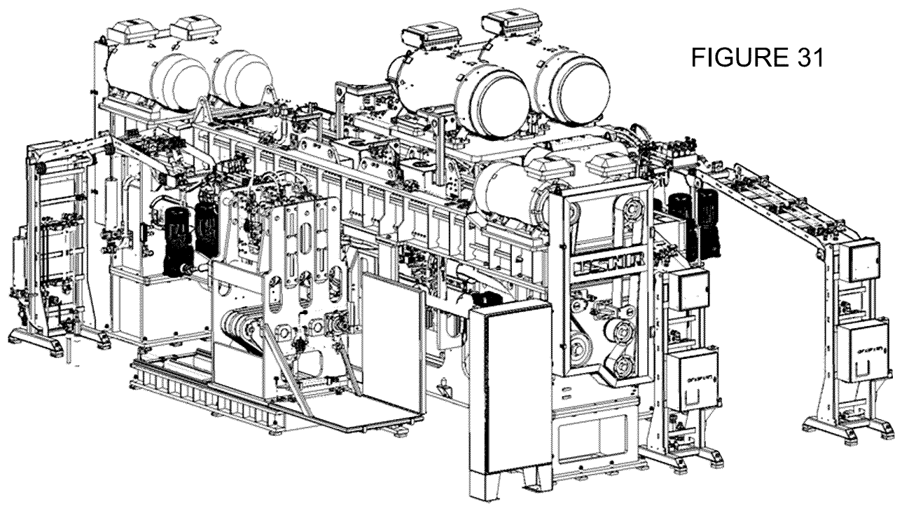

FIGS. 30 and 31 show additional perspective views of system 100, viewed from downstream of outfeed module 600 (FIG. 30) and upstream of infeed module 200 (FIG. 31). Optionally, system 100 may lack a serpentine chain; all rolls may be driven by coupled gearbox or driveline. Flexible belt drives may optionally only be used on each of the cutting tool drive assemblies. Some of the components may optionally be provided as quick-change assemblies, as discussed further below.

Optionally, some or all of the control systems may be factory pre-wired back to central control enclosures on the service side of machine outside of the lock-out barrier. Allocations may be made for all arbor motor wiring connections on the fixed connection point of the machine. Bedrolls and press rolls may optionally be driven on a common side and fixed in position, reducing the need for complex motor wiring systems.

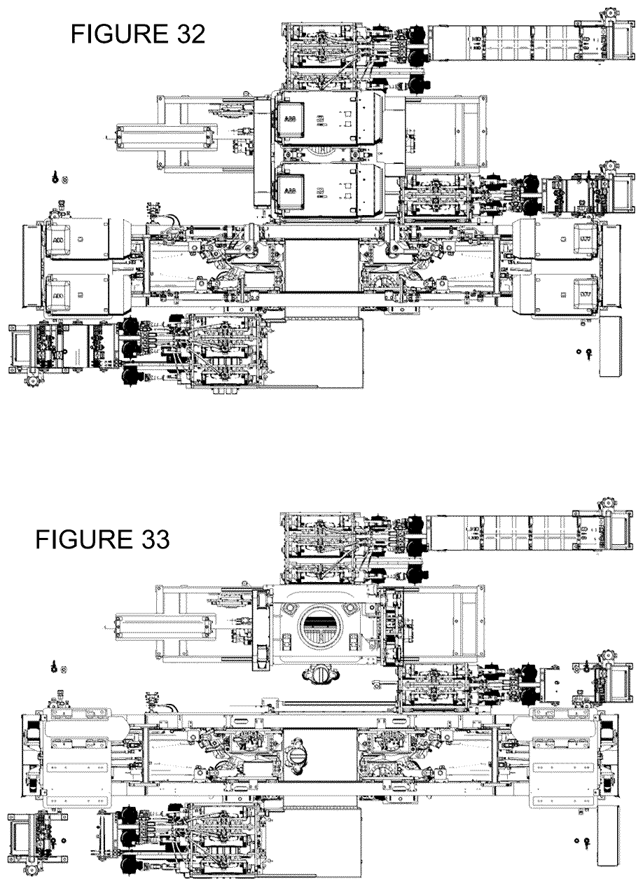

FIGS. 32 and 33 provide further plan views of the system 100, with the system in ‘saw change mode.’ As described above, some modules of system 100 (e.g., infeed module 200 and mid-feed module 400) may have self-deploying platforms or floors that extend over openings provided in the floor for residuals (e.g., sawdust, wood chips, etc.). This design allows saws and chipper knives to be changed by an operator standing on the platforms (see FIG. 33).

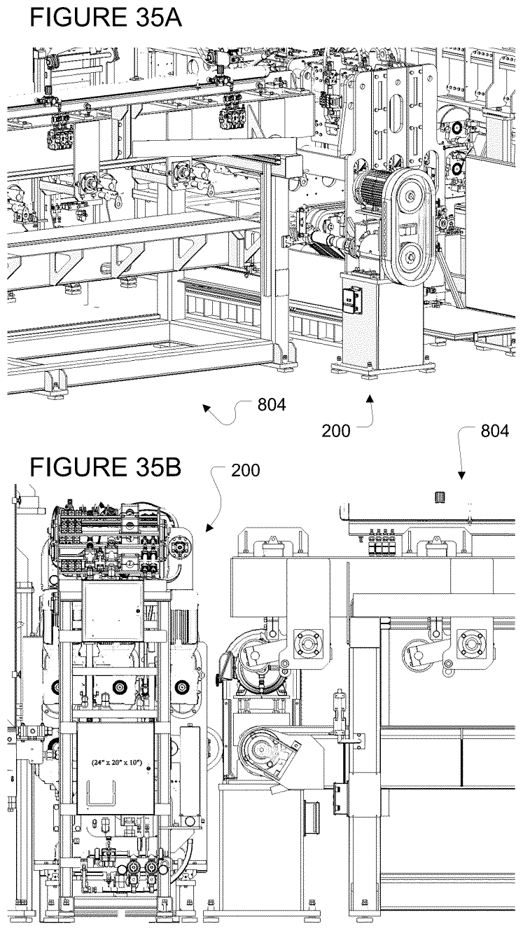

FIGS. 35A and 35B show perspective and side elevational views, respectively, of the interface between a downstream end of the bridge portion 802 of centering infeed 800 and infeed module 200. In some embodiments, bridge portion 802 and infeed module 200 may be mechanically connected. In other embodiments, they may be separated by a small gap (e.g., less than 2 feet). In either case, the feed axis that extends through infeed module 200 preferably extends through bridge portion 802. Some embodiments may lack centering infeed 800.

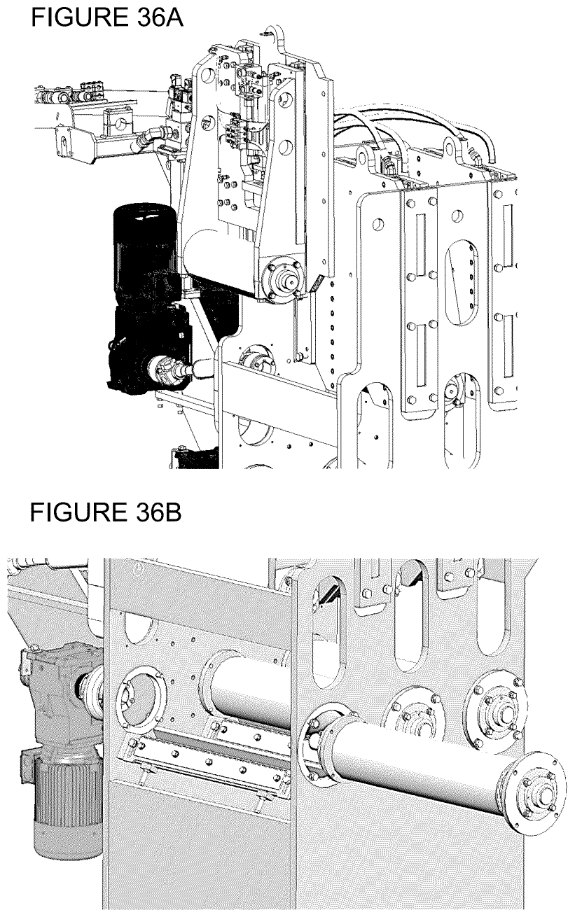

Additional views of the feed modules 200/400/600 are shown in FIGS. 36A and 36B. In some embodiments, some or all of the reducers may optionally be shared across motors. Optionally the lower feed rolls may be quick change assemblies, which may be easier to service than traditional feed rolls. In some embodiments the upper feed (press) rolls are all hydraulic with position and force control. Again, the upper feed (press) rolls may be lift-out assemblies for ease of maintenance.

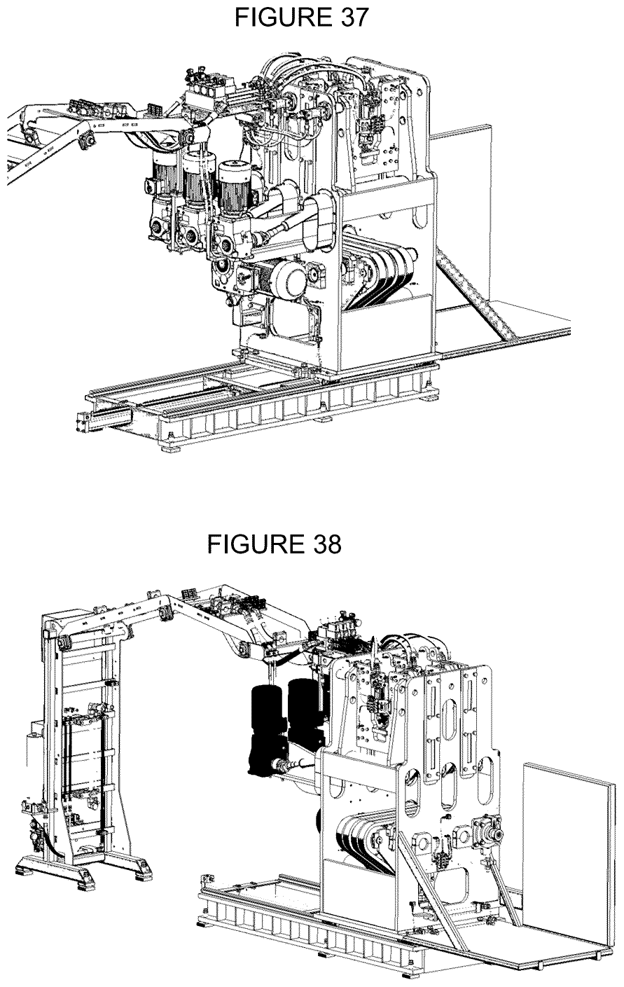

Referring now to FIGS. 37, 38, and 39, infeed module 200 may ride on linear rails to move out of the way and deploy the maintenance platform automatically during knife and saw change. Optionally, the infeed module 200 may be the only module in the system 100 that utilizes a chain bed. The upper feed roll modules may be the same lift-out design that is used in the mid-feed and outfeed modules. Optionally the upper feed rolls (press rolls) may be directly driven through a driveline and a right-angle reducer, and the lower feed rolls (bed rolls) may be directly driven through a coupling and either a right-angle reducer or an inline reducer.

As described above, the feed assembly 420 of the mid-feed module 400 may ride along linear rails that are mounted on the frame 402 (see also FIGS. 40, 41, and 42), allowing the feed assembly 420 to move out of the way during saw and knife change. Again, the upper feed rolls and the lower feed rolls of the mid-feed module 400 may optionally have a lift-out design for easier maintenance and replacement. Similarly, some or all of the rolls of the mid-feed module may be directly driven through a driveline and a 90-degree reducer.

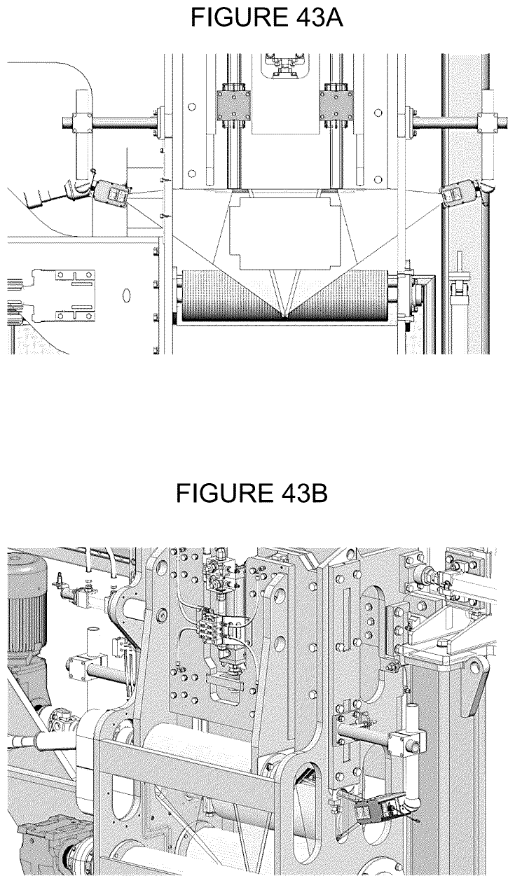

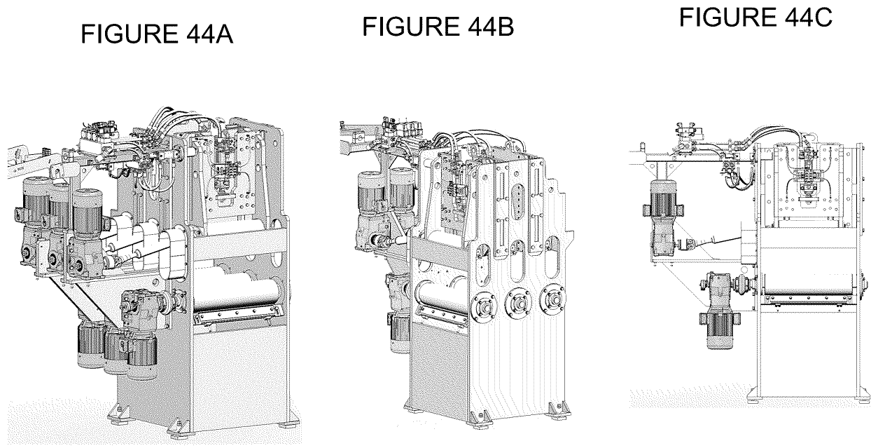

Optionally, system 100 may be provided with an optimization system/software. For example, geometric (e.g., laser profile) sensors and/or vision cameras may be positioned to scan workpieces as they pass through infeed module 200 (see FIGS. 43A and 43B), and the scan data may be used by the optimization system to adjust the chipping and profiling equipment. In some embodiments the optimizing system may use the scan data to automatically adjust for bias while system 100 is operating. Additional views of the outfeed module 600 are shown in FIGS. 44A, 44B, and 44C. Optionally, the outfeed module 600 may be stationary and positioned at the outfeed end of the saw module 500. Preferably the upper and lower feed rolls of the outfeed module 500 have the same lift-out design as the mid-feed module 400. Again, some or all of the feed rolls of the outfeed module may be directly driven through a driveline and a 90-degree reducer.

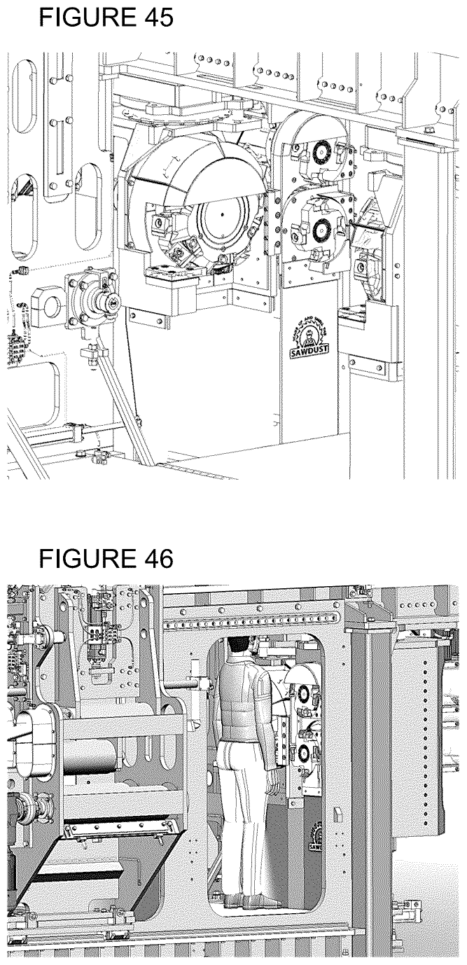

Referring now to FIGS. 45, 46, and 47, chipper profiler module 300 is preferably capable of processing up to 12″ nominal cants and adjusting to follow the curve of the cant. Added support from feed rolls may help to ensure feeding accuracy during processing. As discussed above, variable profiler heads may allow the system 100 to produce slewed sideboards solutions. Moreover, the conical chip heads in chipper profiler module 300 may require less feed forward force than drum chip heads.

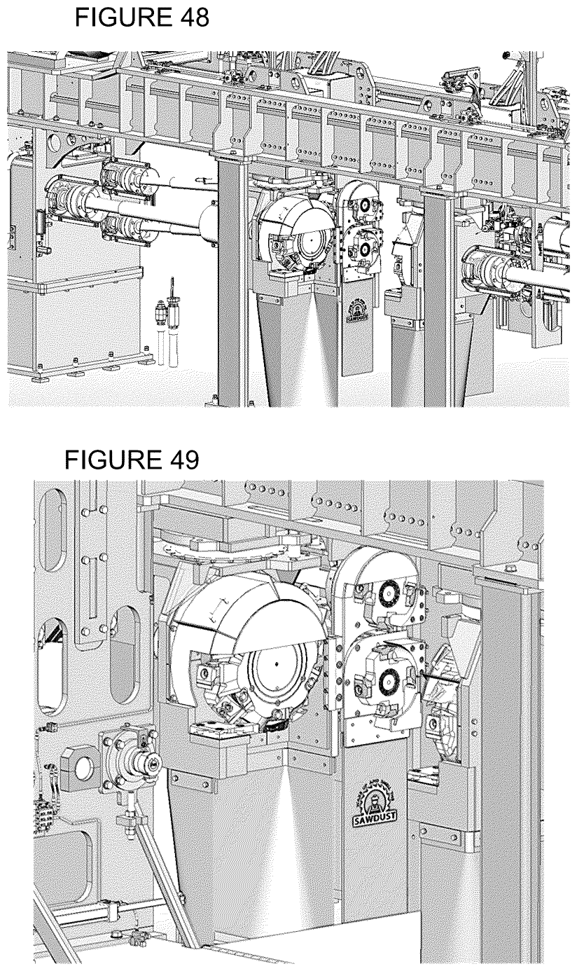

The profiling heads of chipper profiler module 300 (see also FIGS. 48 and 49) are operable to “pre-edge” side boards along the cant before the side boards are sawn free of the cant. The profiler heads may be capable of profiling 2×3 inch jacket boards. Using the profiling heads to pre-edge side/jacket boards along the cant may reduce or avoid problems associated with conveying and processing flitches. Profiling also reduces edger load, as fewer (or no) flitches must pass through the edger. Profiling also reduces the depth of cut required to cut the piece from the cant, in comparison to cutting a flitch. This reduction in the depth of cut may enhance throughput. As an example, in some cases profiling may increase throughput (in comparison to cutting flitches and sending them to the edger) by up to 4½ pieces per minute. Similarly, the reduction in pieces sent to the edger kay help to increase edger capacity. As an example, in some cases this reduction may increase edger capacity by an average of 2.6 pieces per log.

Optionally, the chipper and profiler heads may operate with ±6 degrees of rotation. The profiler heads and the canter heads may be positionable independently of one another to accurately follow the solution curve. Preferably, both are operable to achieve a 96′ curved radius or 4″ in 16′ on the curved solution. The upper feed (press) rolls may optionally be configured to adjust dynamically to any variability of a cant's thickness to maintain a preset clamping force. For example, they may be configured to be adjusted automatically through hydraulic force control, which may also aid in stability.

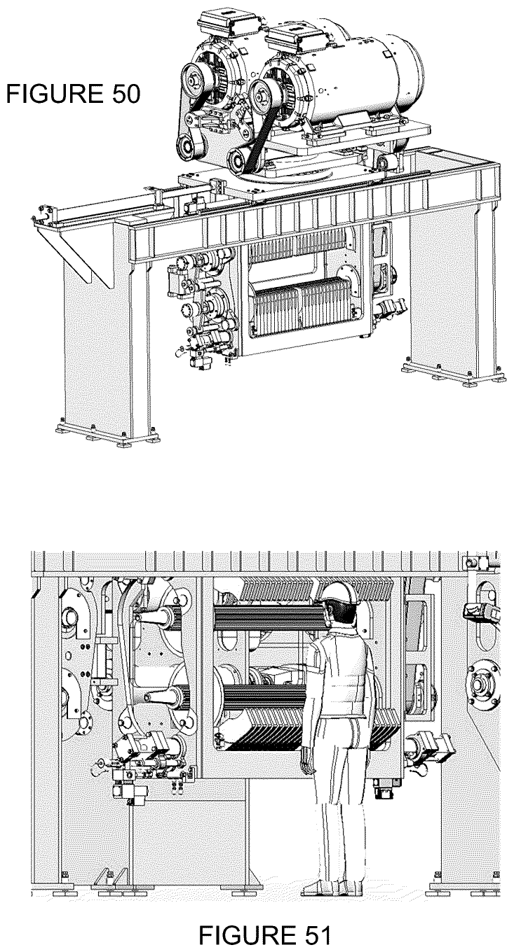

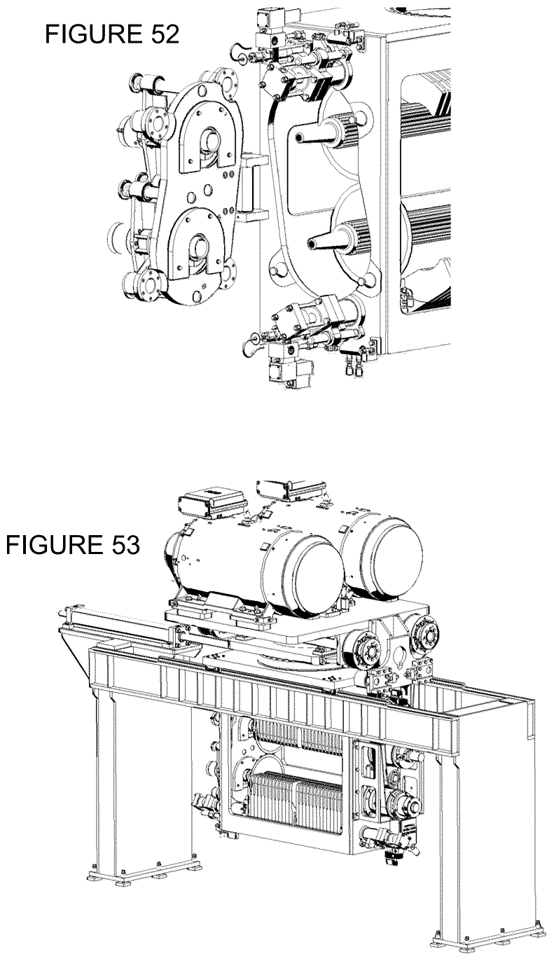

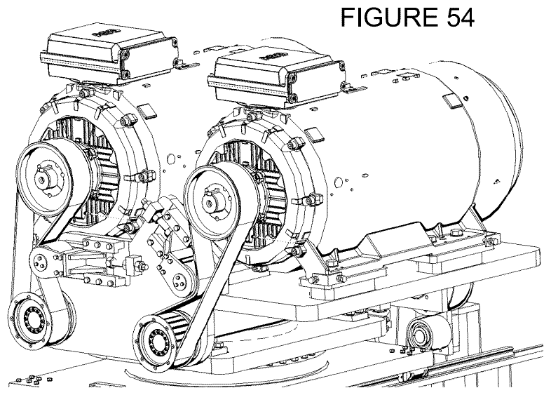

Additional views of the saw module 500 are shown in FIGS. 50-54. As discussed above, the saw module 500 may have a ring bearing (also known as a turret bearing or a slewing bearing) and a pivot actuator (e.g., a cylinder or other linear actuator) to enable rotation of the saw box (FIG. 50). The saw box is vertically movable to allow the cut depth to be balanced between the top and bottom arbors. FIG. 51 shows a perspective partial view of the saw module 500 in ‘saw change mode.’ Saw module 500 may optionally have automatic saw mismatch adjustment with setworks, with cylinders on both top and bottom arbor guide bar assemblies. This adjustment may also allow for automatic adjustment to offset arbor wear. Vertically stacked guides may allow for better access during saw change. In FIG. 52, the saw box door is shown in ‘saw change mode.’ In this mode, the saw box door may clamp and unclamp to the saw box and arbors automatically. In addition, the door may open outwardly and out of the way to provide as much room as possible for saw change. Arbors are preferably secured from the drive side of the system to ensure that the arbors remain level during saw changes. Optionally the arbor drive belts may have resettable torque limiters, and each arbor may be driven by a two-belt drive assembly (see FIGS. 53 and 54).

The short-coupled design of system 100 may help to ensure that the shortest cants are secured through the system during processing, reducing the chance of sticking in the system or damaging the equipment. The system may optionally handle cants as short as 86-inches (7′ 2″) while maintaining contact with at least two press rolls.

Embodiments of systems described herein may have one or more advantages over prior chipping, profiling, and/or sawing systems. For example, some embodiments of systems described herein may be faster and/or less costly to install. The systems described herein may be modular in design, allowing for shipping to the installation site as substantially complete modules that require less time and work to complete. As another example, some systems described herein may fit into a smaller envelope or space (thus requiring less rework of existing machinery). The systems described herein may be simpler to maintain than prior systems and/or provide easier access for service and changing saw blades and/or other components. Having a more closely coupled arrangement may also reduce complications of conveying workpieces and processing defects attributable to errors in workpiece handoff from one machine center to the next, which may result from longer distances between cutting and holding systems.

Optionally, some or all of the control systems may be factory pre-wired back to central control enclosures on the service side of machine outside of the lock-out barrier. Allocations may be made for all arbor motor wiring connections on the fixed connection point of the machine. Bedrolls and press rolls may optionally be driven on a common side and fixed in position, reducing the need for complex motor wiring systems.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. An apparatus for sawing a cant longitudinally as the cant is moved lineally along a feed axis in a first direction, the apparatus comprising:
a frame having a pair of horizontal beams that are disposed above, and transverse to, the feed axis and spaced apart along the first direction;
a first support assembly having a first platform, the first platform being supported on, and slideably mounted to, the horizontal beams; and
a saw box movably coupled with the first support assembly such that the saw box is supported by the beams and disposed below the beams,
wherein the first support assembly is movable, relative to the beams, in opposite directions along a horizontal path that is above and transverse to the feed axis to thereby move the saw box laterally relative to the feed axis,
wherein the saw box is pivotable, relative to the first support assembly, about a vertical axis; and
wherein the saw box is vertically movable relative to the first support assembly.

2. The apparatus of claim 1, further including a second support assembly supported by, and pivotably coupled to, the first support assembly,
wherein the second support assembly includes a second platform and a cylinder, the second platform is disposed above the first platform, the cylinder extends through the first platform and between the beams, and a first end of the cylinder is fixedly coupled to the second platform,
wherein the saw box is fixedly coupled to an opposite second end of the cylinder such that the saw box is supported by the second support assembly,
wherein the vertical axis is defined by the cylinder and the second support assembly is pivotable, relative to the first support assembly, about the vertical axis to thereby pivot the saw box about the vertical axis, and
wherein the second platform and the cylinder are vertically movable, relative to the first platform, to thereby raise and lower the saw box.

3. The apparatus of claim 2, wherein the first support assembly further includes a ring bearing having an outer ring and an inner ring, the outer ring being fixedly mounted to the first platform and the inner ring being rotatable relative to the outer ring.

4. The apparatus of claim 3, wherein the second support assembly further includes a third platform and a cylindrical tube, wherein the third platform is disposed between the first platform and the second platform, the cylindrical tube is fixedly mounted to the third platform and the inner ring, and the cylinder is disposed through the cylindrical tube.

5. The apparatus of claim 4, further including a first actuator mounted to the first platform and pivotably coupled to the third platform, wherein the first actuator is actuable to pivot the second support assembly and the saw box around the vertical axis relative to the first platform.

6. The apparatus of claim 5, further including a second actuator mounted to the second platform and connected to the third platform, wherein the second actuator is actuable to raise and lower the second platform relative to the third platform to thereby raise and lower the saw box relative to the feed axis.

7. The apparatus of claim 1, further including a linear actuator mounted to the frame and connected to the first platform, wherein the linear actuator is actuable to move the first support assembly, relative to the beams, in opposite directions along the horizontal path to thereby move the saw box laterally relative to the feed axis.

8. The apparatus of claims 2, further including:
an upper saw arbor and a lower saw arbor rotatably mounted to the saw box; and
a first motor and a second motor operatively coupled with the first saw arbor and the second saw arbor, respectively, and supported on the second platform, wherein the first motor and the second motor are operable to drive the first and second arbors, respectively, in rotation.

9. An apparatus for chipping and profiling a workpiece longitudinally as the workpiece is moved lineally along a feed axis in a first direction, wherein the workpiece is a log or a cant, the apparatus comprising:
a frame having a first beam and a second beam that are disposed above, and transverse to, the feed axis, parallel to one another, and spaced apart along the first direction,
a first chipper assembly slideably mounted to the first beam, and
a first profiler assembly slideably mounted to the second beam, wherein the first chipper assembly and the first profiler assembly are movable independently of one another, along respective horizontal paths, in a first direction toward the feed axis and in a second direction away from the feed axis.

10. The apparatus of claim 9, wherein the first chipper assembly has a first upper carriage assembly and a first lower carriage assembly, the first upper carriage assembly has a first carriage configured to slideably engage a first rail disposed along the first beam, the first lower carriage assembly is coupled to the first upper carriage assembly and rotatable relative thereto about a first vertical axis, and the first lower carriage assembly is configured to support a chipping head.

11. The apparatus of claim 9, wherein the first profiler assembly has a second upper carriage assembly and a second lower carriage assembly, the second upper carriage assembly has a second carriage configured to slideably engage a second rail disposed along the second beam, the second lower carriage assembly is coupled to the second upper carriage assembly and rotatable about a second vertical axis, and the second lower carriage assembly is configured to support an upper profiler head and a lower profiler head.

12. The apparatus of claim 11, wherein the second lower carriage assembly includes a support, and the upper profiler head and the lower profiler head are movably mounted to the support such that the upper profiler head and the lower profiler head are vertically movable independently of one another relative to the support.

13. The apparatus of claim 9, wherein each of the first and second beams has a top and a bottom joined by an upstream side and a downstream side, and the first beam is upstream of the second beam, the first chipper assembly is slideably mounted to the downstream side of the first beam, and the first profiler assembly is slideably mounted to the upstream side of the second beam, such that a portion of the first profiler assembly and a portion of the second profiler assembly are between the first beam and the second beam.

14. The apparatus of claim 13, further including a first set of rails mounted to the downstream side of the first beam and a second set of rails mounted to the upstream side of the second beam, each of the sets of rails having a respective upper rail and a respective lower rail that extend horizontally and parallel to one another, the first chipper assembly has a first set of carriages slideably mounted to the first set of rails, and the first profiler assembly has a second set of carriages slideably mounted to the second set of rails.

15. The apparatus of claim 9, wherein the first chipper assembly includes a first chip head, the first profiler assembly includes an upper profiler head and a lower profiler head, the first chip head is pivotable about a first vertical axis, the upper and lower profiler heads are pivotable about a second vertical axis independently of the first chip head, and the upper profiler head and the lower profiler head are vertically movable independently of one another.

16. The apparatus of claim 9, further including a feed assembly mounted to a downstream end of the frame and movable laterally, relative to the frame, between an operational position in which the feed axis extends through the feed module and a maintenance position in which the feed module is located to one side of the feed axis.

17. A feed module for feeding a workpiece axially in a first direction along a feed axis, the feed module comprising:
a base;
a feed assembly having a frame and a plurality of opposing feed members rotatably coupled to the frame to form a feed opening; and
a platform assembly mounted to a first side of the frame, wherein the platform assembly includes a first platform that extends from the first side of the frame,
wherein the feed assembly is slideably mounted to the base such that the feed assembly is laterally movable, relative to the base, from an operational position in which the feed axis extends through the feed opening to a maintenance position in which the feed axis extends over the fixed platform.

18. The feed module of claim 17, wherein the platform assembly further includes a second platform movably mounted to the first platform such that the second platform is movable from an upright position to a support position in which an upper surface of the second platform is substantially horizontal or coplanar with an upper surface of the first platform.

19. The feed module of claim 18, wherein the second platform is mounted to a downstream end of the first platform, and wherein the first platform and the second platform are below, and in alignment with, the feed axis and the second platform when the feed assembly is in the maintenance position and the second platform is in the support position.

20. The feed module of claim 17, wherein the opposing feed members include a plurality of upper feed roll assemblies and a workpiece support surface with one or more endless members.
